(19) United States
(12) Patent Application Publication
(10) Pub. No.: US 2026/0036675 A1
(43) Pub. Date: Feb. 5, 2026

(54) RADAR SENSOR CALIBRATION TECHNIQUES FOR HYDRAULIC CYLINDERS

(71) Applicant: Pacoma GmbH, Eschwege (DE)

(72) Inventors: Martin Luessi, Portland, OR (US); Jim McKee, Eschwege (DE)

(21) Appl. No.: 19/288,652

(22) Filed: Aug. 1, 2025

Related U.S. Application Data
(60) Provisional application No. 63/678,820, filed on Aug. 2, 2024.

(51) Int. Cl. G01S 7/40; G01S 13/88

(52) U.S. Cl. CPC G01S 7/4021; G01S 13/88

(57) ABSTRACT

A method, system and non-transitory machine-readable storage devices for calibrating a radar sensor used in a hydraulic cylinder includes calculating a position-dependent noise estimate. The calibration also includes setting a position-dependent threshold amplitude for piston position detection based on the calculated position-dependent noise estimate. A piston is determined to be detected at a particular position if a reflected signal received at the radar sensor exceeds the position-dependent threshold amplitude at the particular position. The calibration further includes calibrating radar measurements acquired by the radar sensor to correct for a multi-path position error.

### CROSS-REFERENCE TO RELATED APPLICATIONS

This application claims priority to U.S. Patent Application Ser. No. 63/678,820, filed Aug. 2, 2024, the entire contents of which are incorporated herein by reference.

### TECHNICAL FIELD

The description generally relates to hydraulic cylinders, for example, used in machinery and/or construction equipment.

### BACKGROUND

Hydraulic cylinders are hydraulic actuators that provide linear motion when hydraulic energy is converted into mechanical movement. Hydraulic cylinders get their power from pressurized hydraulic fluid. The hydraulic fluid is typically an incompressible (or a substantially incompressible) fluid. In some hydraulic cylinders, a position of a piston within the hydraulic cylinder can be measured, for example, using a high-frequency electromagnetic sensing unit (e.g., a radar sensing unit that includes a radar sensor operating in a microwave band, a millimeter wave band, etc.).

### SUMMARY

This document describes systems and methods for taking radar measurements of a position of a piston within a hydraulic cylinder. For example, radar measurements can be obtained by using a high-frequency electromagnetic sensing unit such as a radar sensing unit that includes a radar sensor operating in a microwave band, a millimeter wave band, etc. The radar sensor can be configured to emit a radar signal within the hydraulic cylinder (e.g., through a hydraulic fluid contained within the cylinder), and receive a reflected signal indicative of a position of the piston within the hydraulic cylinder.

For simplicity, this specification describes example implementations of the invention primarily with reference to radar sensing units that emit and detect electromagnetic signals in the millimeter wave band (e.g., at approximately 60 GHz). It should be understood, however, that the disclosed techniques are equally applicable to other suitable high-frequency electromagnetic signals including suitable signals in the microwave band.

The radar measurements of the piston position obtained by a radar sensing unit can be influenced by a variety of factors. For example, the reflected signal received at the radar sensing unit can be dependent on the geometry and size of the hydraulic cylinder, a material of the hydraulic cylinder, a composition of the fluid within the hydraulic cylinder, etc. Relatedly, the reflected signal received at the radar sensing unit can be dependent on reflections of the emitted radar signal within the hydraulic cylinder. While the radar signal that travels along the direct path from the radar sensor to the piston and back is received first at the radar sensor, other signals that take indirect paths (e.g., reflecting off a wall of the cylinder) can arrive later with similar or even larger magnitude than the signal traveling along the direct path. This can result in constructive and deconstructive interference and can yield a position-dependent error in the measured position of the piston within the hydraulic cylinder (referred to sometimes herein as a “multi-path position error”).

The position-dependent error can further be caused by radar chip characteristics (e.g., contributing substantially to noise when the piston is very close to the radar sensor), and by attenuation of the radar signal as the radar signal travels through the cylinder to positions that are farther away from the radar sensor. The reflected signal received at the radar sensing unit can also be dependent on a temperature within the hydraulic cylinder (e.g., the temperature of the hydraulic fluid within the hydraulic cylinder). For instance, the dielectric constant of the fluid can be dependent on the temperature of the fluid and thus fluctuations in temperature can alter the propagation velocity of the radar signal in the fluid and thus affect the estimated position of the piston within the hydraulic cylinder. The techniques described in this specification can overcome the foregoing technical problems by calibrating and/or otherwise adjusting the measurements of the piston position obtained by the radar sensing unit to improve the accuracy of such measurements. The techniques described in this specification also allow for information about the position-dependent error to be stored in the radar sensor such that the radar sensor can adjust raw position measurements based on the position-dependent error, thereby improving accuracy of radar-based measurements that estimate the position of the piston in the hydraulic cylinder.

In one aspect, a method for calibrating a radar sensor used in a hydraulic cylinder is featured. The method includes calculating a position-dependent noise estimate. The method also includes setting a position-dependent threshold amplitude for piston position detection based on the calculated position-dependent noise estimate. A piston is determined to be detected at a particular position if a reflected signal received at the radar sensor exceeds the position-dependent threshold amplitude at the particular position. The method also includes calibrating radar measurements acquired by the radar sensor to correct for a multi-path position error.

Implementations can include the examples described below and herein elsewhere. In some implementations, the method further includes collecting, using the radar sensor, error measurements at multiple temperatures within the hydraulic cylinder, wherein the error measurements represent a difference between (i) the calibrated radar measurements and (ii) reference positions of the piston that correspond to the calibrated radar measurements; and calibrating the radar measurements acquired by the radar sensor to adjust for temperature fluctuations within the hydraulic cylinder. In some implementations, the reference positions of the piston that correspond to the calibrated radar measurements can be provided by a reference position sensor. In some implementations, the reference position sensor can include a glass scale encoder coupled to the hydraulic cylinder. In some implementations, calculating the position-dependent noise estimate can include setting a fixed threshold amplitude for piston position detection; collecting radar measurements at multiple positions between the radar sensor and the piston; and estimating noise statistics at the multiple positions between the radar sensor and the piston using the radar measurements. In some implementations, wherein setting the position-dependent threshold amplitude for piston position detection can include automatically setting the position-dependent threshold amplitude for piston position detection based on the calculated position-dependent noise estimate. In some implementations, automatically setting the position-dependent threshold amplitude for piston position detection based on the calculated position-dependent noise estimate can include automatically setting the position-dependent threshold amplitude for piston position detection at a defined number of standard deviations above a mean value of the calculated position-dependent noise estimate. In some implementations, calibrating the radar measurements acquired by the radar sensor to correct for the multi-path position error can include collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions. In some implementations, determining the function that estimates the multi-path position error at various piston positions can include fitting a B-spline curve to error measurements that represent differences between (i) the uncalibrated piston position measurements collected using the radar sensor and (ii) the reference positions of the piston that correspond to the uncalibrated piston position measurements. In some implementations, calibrating the radar measurements acquired by the radar sensor to adjust for temperature fluctuations within the hydraulic cylinder can include determining a function for estimating a temperature correction that minimizes an error between (i) the calibrated radar measurements and (ii) the reference positions of the piston that correspond to the calibrated radar measurements; and adjusting the calibrated radar measurements by the temperature correction estimated by the determined function. In some implementations, determining the function for estimating the temperature correction that minimizes the error between (i) the calibrated radar measurements and (ii) the reference positions of the piston that correspond to the calibrated radar measurements can include determining one or more coefficients corresponding to an approximation of the error between (i) the calibrated radar measurements and (ii) the reference positions of the piston that correspond to the calibrated radar measurements. In some implementations, the method can further include defining a plurality of sections of the hydraulic cylinder; identifying that the piston is likely to be present in a particular section of the plurality of sections of the hydraulic cylinder; and varying one or more measurement parameters to pre-defined values corresponding to the particular section. In some implementations, the one or more measurement parameters can include at least one of a receiver gain associated with the radar sensor or a number of measurements averaged by the radar sensor. In some implementations, the method can further include defining a plurality of sections of the hydraulic cylinder; identifying that the piston is likely to be present in a particular section of the plurality of sections of the hydraulic cylinder; and operating the radar sensor to acquire data only for the particular section.

In some implementations, the method includes determining (i) an initial estimated position of the piston in the hydraulic cylinder and (ii) a temperature measurement representative of a temperature associated with the hydraulic cylinder. In some implementations, the temperature measurement is a measurement of a temperature of a fluid within the hydraulic cylinder.

In some implementations, the method includes determining a plurality of calibration temperatures based on a temperature parameter associated with the hydraulic cylinder. The method includes determining a plurality of calibration positions based on the initial estimated position. A plurality of defined sections includes the plurality of calibration positions. The plurality of defined sections span a length of a cylinder body of the hydraulic cylinder. Each section from the plurality of defined sections corresponds to a respective portion of the length of the cylinder body. The method includes generating a plurality of functions based on the plurality of calibration positions and the plurality of calibration temperatures. Each function from the plurality of functions estimates the multi-path position error at various piston positions of the hydraulic cylinder. Each function from the plurality of functions is generated from a respective combination of at least one temperature from the plurality of calibration temperatures and at least one calibration position from the plurality of calibration positions.

In some implementations, determining the function that estimates the multi-path position error at various piston positions includes selecting one or more functions from the plurality of functions based on a first estimated position of the piston in the hydraulic cylinder and a first temperature parameter of the hydraulic cylinder.

In some implementations, the method includes predicting, using the one or more selected functions, the multi-path position error, wherein the predicting comprises reducing, using the one or more selected functions, an error between (i) the calibrated radar measurements and (ii) the reference positions of the piston that correspond to the calibrated radar measurements. The method can include adjusting the calibrated radar measurements by the multi-path position error predicted by the one or more selected functions.

In an aspect, a system includes at least one processor and one or more storage devices communicatively coupled to the at least one processor, the one or more storage devices storing instructions which, when executed by the at least one processor, cause the at least one processor to perform operations. The operations include calculating a position-dependent noise estimate. The operations include setting a position-dependent threshold amplitude for piston position detection based on the calculated position-dependent noise estimate. A piston is determined to be detected at a particular position if a reflected signal received at the radar sensor exceeds the position-dependent threshold amplitude at the particular position. The operations include calibrating radar measurements acquired by the radar sensor to correct for a multi-path position error.

In an aspect, one or more non-transitory machine-readable storage devices having encoded thereon computer readable instructions for causing one or more processing devices to perform operations for calibrating a radar sensor used in a hydraulic cylinder. The operations include calculating a position-dependent noise estimate. The operations include setting a position-dependent threshold amplitude for piston position detection based on the calculated position-dependent noise estimate. A piston is determined to be detected at a particular position if a reflected signal received at the radar sensor exceeds the position-dependent threshold amplitude at the particular position. The operations include calibrating radar measurements acquired by the radar sensor to correct for a multi-path position error.

In another aspect, another method for calibrating a radar sensor used in a hydraulic cylinder is featured. The method includes determining a position-dependent noise estimate. The method can include configuring a position-dependent threshold amplitude for piston position detection based on the calculated position-dependent noise estimate, wherein a piston is determined to be detected at a particular position in response to receiving a reflected signal at the radar sensor. The reflected radar signal exceeds the position-dependent threshold amplitude at the particular position. The method can include calibrating radar measurements acquired by the radar sensor to correct for a multi-path position error.

In some implementations, the reference positions of the piston that correspond to the calibrated radar measurements are measurements of the reference positions collected by a reference position sensor.

In some implementations, determining the function that estimates the multi-path position error at various piston positions includes determining a B-spline curve corresponding to error measurements representing differences between (i) the uncalibrated piston position measurements collected using the radar sensor and (ii) the reference positions of the piston that correspond to the uncalibrated piston position measurements.

In some implementations, determining the function for estimating the temperature correction that reduces the error between (i) the calibrated radar measurements and (ii) the reference positions of the piston that correspond to the calibrated radar measurements includes determining one or more coefficients corresponding to an approximation of the error between (i) the calibrated radar measurements and (ii) the reference positions of the piston that correspond to the calibrated radar measurements.

In some implementations, the method includes determining that the piston is likely to be present in a particular section of a plurality of sections that span a length of a cylinder body of the hydraulic cylinder. Each section corresponds to a respective portion of the length of the cylinder body. The method includes adjusting one or more measurement parameters to values corresponding to the particular section from the plurality of sections.

In another aspect, another method for calibrating a radar sensor used in a hydraulic cylinder is featured. The method includes collecting, using the radar sensor, error measurements at multiple temperatures within the hydraulic cylinder, wherein the error measurements represent a difference between (i) radar measurements acquired by the radar sensor and (ii) reference positions of a piston that correspond to the radar measurements. The method also includes calibrating the radar measurements acquired by the radar sensor to adjust for temperature fluctuations within the hydraulic cylinder.

Implementations can include the examples described below and herein elsewhere. In some implementations, the method can include calculating a position-dependent noise estimate; and setting a position-dependent threshold amplitude for piston position detection based on the calculated position-dependent noise estimate, wherein the piston is determined to be detected at a particular position if a reflected signal received at the radar sensor exceeds the position-dependent threshold amplitude at the particular position. In some implementations, the method can include calibrating radar measurements acquired by the radar sensor to correct for a multi-path position error. In some implementations, the reference positions of the piston that correspond to the radar measurements can be provided by a reference position sensor. In some implementations, the reference position sensor can include a glass scale encoder coupled to the hydraulic cylinder. In some implementations, calculating the position-dependent noise estimate can include setting a fixed threshold amplitude for piston position detection; collecting radar measurements at multiple positions between the radar sensor and the piston; and estimating noise statistics at the multiple positions between the radar sensor and the piston using the radar measurements. In some implementations, setting the position-dependent threshold amplitude for piston position detection can include automatically setting the position-dependent threshold amplitude for piston position detection based on the calculated position-dependent noise estimate. In some implementations, automatically setting the position-dependent threshold amplitude for piston position detection based on the calculated position-dependent noise estimate can include automatically setting the position-dependent threshold amplitude for piston position detection at a defined number of standard deviations above a mean value of the calculated position-dependent noise estimate. In some implementations, calibrating the radar measurements acquired by the radar sensor to correct for the multi-path position error can include collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions. In some implementations, determining the function that estimates the multi-path position error at various piston positions can include fitting a B-spline curve to error measurements that represent differences between (i) the uncalibrated piston position measurements collected using the radar sensor and (ii) the reference positions of the piston that correspond to the uncalibrated piston position measurements. In some implementations, calibrating the radar measurements acquired by the radar sensor to adjust for temperature fluctuations within the hydraulic cylinder can include determining a function for estimating a temperature correction that minimizes an error between (i) the radar measurements acquired by the radar sensor and (ii) the reference positions of the piston that correspond to the radar measurements; and adjusting the radar measurements by the temperature correction estimated by the determined function. In some implementations, determining the function for estimating the temperature correction that minimizes the error between (i) the radar measurements acquired by the radar sensor and (ii) the reference positions of the piston that correspond to the radar measurements can include determining one or more coefficients corresponding to an approximation of the error between (i) the radar measurements acquired by the radar sensor and (ii) the reference positions of the piston that correspond to the radar measurements. In some implementations, the method can further include defining a plurality of sections of the hydraulic cylinder; identifying that the piston is likely to be present in a particular section of the plurality of sections of the hydraulic cylinder; and varying one or more measurement parameters to pre-defined values corresponding to the particular section. In some implementations, the one or more measurement parameters can include at least one of a receiver gain associated with the radar sensor or a number of measurements averaged by the radar sensor. In some implementations, the method can further include defining a plurality of sections of the hydraulic cylinder; identifying that the piston is likely to be present in a particular section of the plurality of sections of the hydraulic cylinder; and operating the radar sensor to acquire data only for the particular section.

In another aspect a system is featured. The system includes a hydraulic cylinder that includes a piston and a radar sensor. The system also includes a noise estimation module configured to calculate a position-dependent noise estimate. The system also includes a threshold amplitude setting module configured to set a position-dependent threshold amplitude for piston position detection based on the calculated position-dependent noise estimate, wherein the piston is determined to be detected at a particular position if a reflected signal received at the radar sensor exceeds the position-dependent threshold amplitude at the particular position. The system also includes a multi-path position error calibration module configured to calibrate radar measurements acquired by the radar sensor to correct for a multi-path position error.

Implementations can include the examples described below and herein elsewhere. In some implementations, the system further includes a temperature calibration module configured to collect, using the radar sensor, error measurements at multiple temperatures within the hydraulic cylinder, wherein the error measurements represent a difference between (i) the calibrated radar measurements and (ii) reference positions of the piston that correspond to the calibrated radar measurements; and calibrate the radar measurements acquired by the radar sensor to adjust for temperature fluctuations within the hydraulic cylinder. In some implementations, the system can include a reference position sensor, wherein the reference positions of the piston that correspond to the calibrated radar measurements are provided by the reference position sensor. In some implementations, the reference position sensor can include a glass scale encoder coupled to the hydraulic cylinder. In some implementations, calculating the position-dependent noise estimate can include setting a fixed threshold amplitude for piston position detection; collecting radar measurements at multiple positions between the radar sensor and the piston; and estimating noise statistics at the multiple positions between the radar sensor and the piston using the radar measurements. In some implementations, setting the position-dependent threshold amplitude for piston position detection can include automatically setting the position-dependent threshold amplitude for piston position detection based on the calculated position-dependent noise estimate. In some implementations, automatically setting the position-dependent threshold amplitude for piston position detection based on the calculated position-dependent noise estimate can include automatically setting the position-dependent threshold amplitude for piston position detection at a defined number of standard deviations above a mean value of the calculated position-dependent noise estimate. In some implementations, calibrating the radar measurements acquired by the radar sensor to correct for the multi-path position error can include collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions. In some implementations, determining the function that estimates the multi-path position error at various piston positions can include fitting a B-spline curve to error measurements that represent differences between (i) the uncalibrated piston position measurements collected using the radar sensor and (ii) the reference positions of the piston that correspond to the uncalibrated piston position measurements. In some implementations, calibrating the radar measurements acquired by the radar sensor to adjust for temperature fluctuations within the hydraulic cylinder can include determining a function for estimating a temperature correction that minimizes an error between (i) the calibrated radar measurements and (ii) the reference positions of the piston that correspond to the calibrated radar measurements; and adjusting the calibrated radar measurements by the temperature correction estimated by the determined function. In some implementations, determining the function for estimating the temperature correction that minimizes the error between (i) the calibrated radar measurements and (ii) the reference positions of the piston that correspond to the calibrated radar measurements can include determining one or more coefficients corresponding to an approximation of the error between (i) the calibrated radar measurements and (ii) the reference positions of the piston that correspond to the calibrated radar measurements.

In another aspect, another system is featured. The system includes a hydraulic cylinder that includes a piston and a radar sensor. The system also includes a temperature calibration module configured to collect, using the radar sensor, error measurements at multiple temperatures within the hydraulic cylinder, wherein the error measurements represent a difference between (i) radar measurements acquired by the radar sensor and (ii) reference positions of a piston that correspond to the radar measurements. The temperature calibration module is also configured to calibrate the radar measurements acquired by the radar sensor to adjust for temperature fluctuations within the hydraulic cylinder.

Implementations can include the examples described below and herein elsewhere. In some implementations, the system further includes a noise estimation module configured to calculate a position-dependent noise estimate; and a threshold amplitude setting module configured to set a position-dependent threshold amplitude for piston position detection based on the calculated position-dependent noise estimate. The piston is determined to be detected at a particular position if a reflected signal received at the radar sensor exceeds the position-dependent threshold amplitude at the particular position. In some implementations, the system can include a multi-path position error calibration module configured to calibrate radar measurements acquired by the radar sensor to correct for a multi-path position error. In some implementations, the system can include a reference position sensor, wherein the reference positions of the piston that correspond to the radar measurements are provided by the reference position sensor. In some implementations, the reference position sensor can include a glass scale encoder coupled to the hydraulic cylinder. In some implementations, calculating the position-dependent noise estimate can include setting a fixed threshold amplitude for piston position detection; collecting radar measurements at multiple positions between the radar sensor and the piston; and estimating noise statistics at the multiple positions between the radar sensor and the piston using the radar measurements. In some implementations, setting the position-dependent threshold amplitude for piston position detection can include automatically setting the position-dependent threshold amplitude for piston position detection based on the calculated position-dependent noise estimate. In some implementations, automatically setting the position-dependent threshold amplitude for piston position detection based on the calculated position-dependent noise estimate can include automatically setting the position-dependent threshold amplitude for piston position detection at a defined number of standard deviations above a mean value of the calculated position-dependent noise estimate. In some implementations, calibrating the radar measurements acquired by the radar sensor to correct for the multi-path position error can include collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions. In some implementations, determining the function that estimates the multi-path position error at various piston positions can include fitting a B-spline curve to error measurements that represent differences between (i) the uncalibrated piston position measurements collected using the radar sensor and (ii) the reference positions of the piston that correspond to the uncalibrated piston position measurements. In some implementations, calibrating the radar measurements acquired by the radar sensor to adjust for temperature fluctuations within the hydraulic cylinder can include determining a function for estimating a temperature correction that minimizes an error between (i) the radar measurements acquired by the radar sensor and (ii) the reference positions of the piston that correspond to the radar measurements; and adjusting the radar measurements by the temperature correction estimated by the determined function. In some implementations, determining the function for estimating the temperature correction that minimizes the error between (i) the radar measurements acquired by the radar sensor and (ii) the reference positions of the piston that correspond to the radar measurements can include determining one or more coefficients corresponding to an approximation of the error between (i) the radar measurements acquired by the radar sensor and (ii) the reference positions of the piston that correspond to the radar measurements.

In another aspect, one or more machine-readable storage devices are featured. The one or more machine-readable storage devices have encoded thereon computer readable instructions for causing one or more processing devices to perform operations for calibrating a radar sensor used in a hydraulic cylinder. The operations include calculating a position-dependent noise estimate. The operations also include setting a position-dependent threshold amplitude for piston position detection based on the calculated position-dependent noise estimate, wherein a piston is determined to be detected at a particular position if a reflected signal received at the radar sensor exceeds the position-dependent threshold amplitude at the particular position. The operations also include calibrating radar measurements acquired by the radar sensor to correct for a multi-path position error.

Implementations can include the examples described below and herein elsewhere. In some implementations, the operations further include collecting, using the radar sensor, error measurements at multiple temperatures within the hydraulic cylinder, wherein the error measurements represent a difference between (i) the calibrated radar measurements and (ii) reference positions of the piston that correspond to the calibrated radar measurements; and calibrating the radar measurements acquired by the radar sensor to adjust for temperature fluctuations within the hydraulic cylinder. In some implementations, the reference positions of the piston that correspond to the calibrated radar measurements can be provided by a reference position sensor. In some implementations, the reference position sensor can include a glass scale encoder coupled to the hydraulic cylinder. In some implementations, calculating the position-dependent noise estimate can include setting a fixed threshold amplitude for piston position detection; collecting radar measurements at multiple positions between the radar sensor and the piston; and estimating noise statistics at the multiple positions between the radar sensor and the piston using the radar measurements. In some implementations, wherein setting the position-dependent threshold amplitude for piston position detection can include automatically setting the position-dependent threshold amplitude for piston position detection based on the calculated position-dependent noise estimate. In some implementations, automatically setting the position-dependent threshold amplitude for piston position detection based on the calculated position-dependent noise estimate can include automatically setting the position-dependent threshold amplitude for piston position detection at a defined number of standard deviations above a mean value of the calculated position-dependent noise estimate. In some implementations, calibrating the radar measurements acquired by the radar sensor to correct for the multi-path position error can include collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions. In some implementations, determining the function that estimates the multi-path position error at various piston positions can include fitting a B-spline curve to error measurements that represent differences between (i) the uncalibrated piston position measurements collected using the radar sensor and (ii) the reference positions of the piston that correspond to the uncalibrated piston position measurements. In some implementations, calibrating the radar measurements acquired by the radar sensor to adjust for temperature fluctuations within the hydraulic cylinder can include determining a function for estimating a temperature correction that minimizes an error between (i) the calibrated radar measurements and (ii) the reference positions of the piston that correspond to the calibrated radar measurements; and adjusting the calibrated radar measurements by the temperature correction estimated by the determined function. In some implementations, determining the function for estimating the temperature correction that minimizes the error between (i) the calibrated radar measurements and (ii) the reference positions of the piston that correspond to the calibrated radar measurements can include determining one or more coefficients corresponding to an approximation of the error between (i) the calibrated radar measurements and (ii) the reference positions of the piston that correspond to the calibrated radar measurements. In some implementations, the operations can further include defining a plurality of sections of the hydraulic cylinder; identifying that the piston is likely to be present in a particular section of the plurality of sections of the hydraulic cylinder; and varying one or more measurement parameters to pre-defined values corresponding to the particular section. In some implementations, the one or more measurement parameters can include at least one of a receiver gain associated with the radar sensor or a number of measurements averaged by the radar sensor. In some implementations, the operations can further include defining a plurality of sections of the hydraulic cylinder; identifying that the piston is likely to be present in a particular section of the plurality of sections of the hydraulic cylinder; and operating the radar sensor to acquire data only for the particular section.

In another aspect, another one or more machine-readable storage devices are featured. The one or more machine-readable storage devices have encoded thereon computer readable instructions for causing one or more processing devices to perform operations for calibrating a radar sensor used in a hydraulic cylinder. The operations include collecting, using the radar sensor, error measurements at multiple temperatures within the hydraulic cylinder, wherein the error measurements represent a difference between (i) radar measurements acquired by the radar sensor and (ii) reference positions of a piston that correspond to the radar measurements. The operations also include calibrating the radar measurements acquired by the radar sensor to adjust for temperature fluctuations within the hydraulic cylinder.

Implementations can include the examples described below and herein elsewhere. In some implementations, the operations can include calculating a position-dependent noise estimate; and setting a position-dependent threshold amplitude for piston position detection based on the calculated position-dependent noise estimate, wherein the piston is determined to be detected at a particular position if a reflected signal received at the radar sensor exceeds the position-dependent threshold amplitude at the particular position. In some implementations, the operations can include calibrating radar measurements acquired by the radar sensor to correct for a multi-path position error. In some implementations, the reference positions of the piston that correspond to the radar measurements can be provided by a reference position sensor. In some implementations, the reference position sensor can include a glass scale encoder coupled to the hydraulic cylinder. In some implementations, calculating the position-dependent noise estimate can include setting a fixed threshold amplitude for piston position detection; collecting radar measurements at multiple positions between the radar sensor and the piston; and estimating noise statistics at the multiple positions between the radar sensor and the piston using the radar measurements. In some implementations, setting the position-dependent threshold amplitude for piston position detection can include automatically setting the position-dependent threshold amplitude for piston position detection based on the calculated position-dependent noise estimate. In some implementations, automatically setting the position-dependent threshold amplitude for piston position detection based on the calculated position-dependent noise estimate can include automatically setting the position-dependent threshold amplitude for piston position detection at a defined number of standard deviations above a mean value of the calculated position-dependent noise estimate. In some implementations, calibrating the radar measurements acquired by the radar sensor to correct for the multi-path position error can include collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions. In some implementations, determining the function that estimates the multi-path position error at various piston positions can include fitting a B-spline curve to error measurements that represent differences between (i) the uncalibrated piston position measurements collected using the radar sensor and (ii) the reference positions of the piston that correspond to the uncalibrated piston position measurements. In some implementations, calibrating the radar measurements acquired by the radar sensor to adjust for temperature fluctuations within the hydraulic cylinder can include determining a function for estimating a temperature correction that minimizes an error between (i) the radar measurements acquired by the radar sensor and (ii) the reference positions of the piston that correspond to the radar measurements; and adjusting the radar measurements by the temperature correction estimated by the determined function. In some implementations, determining the function for estimating the temperature correction that minimizes the error between (i) the radar measurements acquired by the radar sensor and (ii) the reference positions of the piston that correspond to the radar measurements can include determining one or more coefficients corresponding to an approximation of the error between (i) the radar measurements acquired by the radar sensor and (ii) the reference positions of the piston that correspond to the radar measurements. In some implementations, the operations can further include defining a plurality of sections of the hydraulic cylinder; identifying that the piston is likely to be present in a particular section of the plurality of sections of the hydraulic cylinder; and varying one or more measurement parameters to pre-defined values corresponding to the particular section. In some implementations, the one or more measurement parameters can include at least one of a receiver gain associated with the radar sensor or a number of measurements averaged by the radar sensor. In some implementations, the operations can further include defining a plurality of sections of the hydraulic cylinder; identifying that the piston is likely to be present in a particular section of the plurality of sections of the hydraulic cylinder; and operating the radar sensor to acquire data only for the particular section.

Various implementations of the technology described herein may provide one or more of the following advantages. First, the technology described herein can reduce errors in the measurement of a piston position within a hydraulic cylinder by accounting for cylinder characteristics such as the geometry and size of the cylinder that may influence the reflected signal received at a radar sensing unit. Second, the technology described herein can reduce errors in the measurement of a piston position within a hydraulic cylinder by counteracting the attenuation of the reflected signal received at the radar sensing unit. For example, the disclosed technology can vary receiver gains for detections associated with different sections of the cylinder and using hardware averaging when the piston is farther away from the radar sensor. Defining sections of the cylinder can also have the advantage of reducing the acquisition time of measurements since data only needs to be acquired for the section of the cylinder where the piston is expected to be located.

As described below, the technology described herein can further reduce errors in the measurement of a piston position with a hydraulic cylinder by correcting for a multi-path position error at various positions of the piston and at various temperatures within the hydraulic cylinder. In some cases, the technology described herein can have the additional advantage of reducing the frequency at which calibration needs to be performed to maintain an acceptable accuracy of piston position measurements (e.g., one calibration process per unique combination of hydraulic cylinder type and radar sensor type). In some implementations, the technology described in this specification allows the system to more accurately estimate multi-path position error under different temperature conditions and at different piston positions or sections of the cylinder. For example, a collection of functions that model multi-path position error at different temperatures and cylinder sections can be derived and stored in a memory accessible to a processor that calculates piston position based on radar measurements. A particular one of the functions from the multiple functions can be selected and applied based on an initial estimate of piston position and a temperature measurement of the cylinder. A function for estimating multi-path position error based on a real-time or near-real time measurement (or interval) for temperature and position can provide a more accurate representation of the multi-path position error, e.g., providing a calibration using a multi-path position error derived with more granularity and precision compared to other temperatures or positions associated with other cylinder sections.

Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF DRAWINGS

FIG. 1A is a flowchart showing a radar sensor calibration process for hydraulic cylinders.

FIG. 1B is a diagram of a system configured to execute operations of the radar sensor calibration process shown in FIG. 1A.

FIG. 2 shows a longitudinal section of a first example of a piston and cylinder unit.

FIG. 3 shows a partial longitudinal section of a second example of a piston and cylinder unit in the area of the cylinder head.

FIG. 4 shows an exploded view of the cylinder head shown in FIG. 3.

FIG. 5 shows a three-dimensional view of a piston movement sensor and a positioning and/or alignment element.

FIG. 6 shows a spatial view of a housing connector with a sensor cable.

FIG. 7 shows the housing connector with sensor cable according to FIG. 6 in a side view.

FIG. 8 shows a three-dimensional view of a housing plug with a sensor cable.

FIG. 9 shows the housing connector according to FIG. 8 in a side view.

FIG. 10A shows a longitudinal section of a third example of a piston and cylinder unit.

FIG. 10B is a close-up view of the longitudinal section of the piston and cylinder unit shown in FIG. 10A.

FIG. 11 is a flowchart showing details of a portion of the radar sensor calibration process for hydraulic cylinders shown in FIG. 1A.

FIG. 12 shows an example plot corresponding to performance of the portion of the radar sensor calibration process for hydraulic cylinders shown in FIGS. 10A and 10B.

FIG. 13 is a flowchart showing a sub-process for calibrating radar measurements to correct for a multi-path position error.

FIG. 14 shows an example plot corresponding to performance of the sub-process shown in FIG. 12.

FIG. 15 is a flowchart showing details of a portion of the radar sensor calibration process for hydraulic cylinders shown in FIG. 1A.

FIGS. 16A-16C show example plots corresponding to performance of the portion of the radar sensor calibration process for hydraulic cylinders shown in FIG. 14.

FIG. 17 shows an example plot corresponding to performance of the sub-process shown in FIG. 13.

FIG. 18 shows another example plot corresponding to performance of the sub-process shown in FIG. 13.

FIG. 19 is a diagram illustrating an example of a computing environment.

Like reference numbers and designations in the various drawings indicate like elements.

### DETAILED DESCRIPTION

A hydraulic cylinder can include a time-of-flight radar sensor to measure a position of the piston in a hydraulic cylinder, such as by transmitting signals and processing characteristics of reflected signals detected by the sensor. For example, the position of a piston can be determined in part by detecting the leading edge of the signal envelope of a reflected signal. The radar sensor can detect the leading edge by detecting a reflected signal and determining whether the amplitude of the detection is above a threshold. The threshold can be determined based on the noise statistics of the returns, such as a false positive rate, also known as constant false alarm rate (CFAR) detection, for example.

By using the leading edge of the signal envelope of the return signal, the radar sensor can detect a target radar signal that travels a shortest and thus most direct path from the radar sensor to the piston, e.g., including the return path from piston back to the radar sensor. In some cases, a target radar signal arrives earlier, e.g., prior to, compared to arrival times of other radar signals, e.g., radar signals that are reflected from the wall of the cylinder and therefore have a longer path length than the target radar signal. In some instances, some positions of the piston can result in radar signals that follow a path (e.g., indirect path or longer path than the target radar signal) that can result in signal amplitudes that have a substantially similar or larger magnitude than the target signal. In some instances, the detection of the piston at some positions can result in interference (e.g., constructive interference, destructive interference) and introduce a position-dependent error in estimating the position of the position along the length of the cylinder, also referred to as a multi-path position error (MPE).

Variations in the MPE can be affected by the geometry of the hydraulic cylinder, properties of the dielectric lens that focuses the radar signal from an emitter of the radar sensor into the cylinder, and the wavelength of the radar signal emitted by the radar sensor, among other factors. The MPE and wavelength of the radar signal as it propagates through the cylinder can also be impacted by the physical properties and composition of the hydraulic fluid. Furthermore, the temperature and pressure of the hydraulic fluid can also affect the MPE. This specification describes techniques for calibrating measurements from a radar sensor to mitigate the effects of MPE and other sources of error in the detection of piston position across different conditions, including different temperature and pressure conditions and for different estimated distances of the piston from the sensor.

For example, the temperature of a hydraulic fluid can affect the propagation velocity of a radar signal through a hydraulic cylinder, which in turn results in variations of the MPE at different temperatures and distances from the radar sensor. By determining multiple MPE functions associated with multiple operating temperatures and for different sections of the cylinder at different distances from the sensor, the accuracy of piston position measurements based on radar signal detections can be significantly improved. Some functions representing the MPE (such as a B-Spline) collected at one operating temperature (Tc) do not optimally represent or model the MPE at different operating temperatures, nor do they account for discontinuities associated with or resulting from boundaries between different sections of the hydraulic cylinder. Implementations of the technology described herein provide a calibration technique that interpolates between cylinder sections having different settings at different temperatures. The disclosed technology can improve error compensation using multiple functions for approximating piston position error.

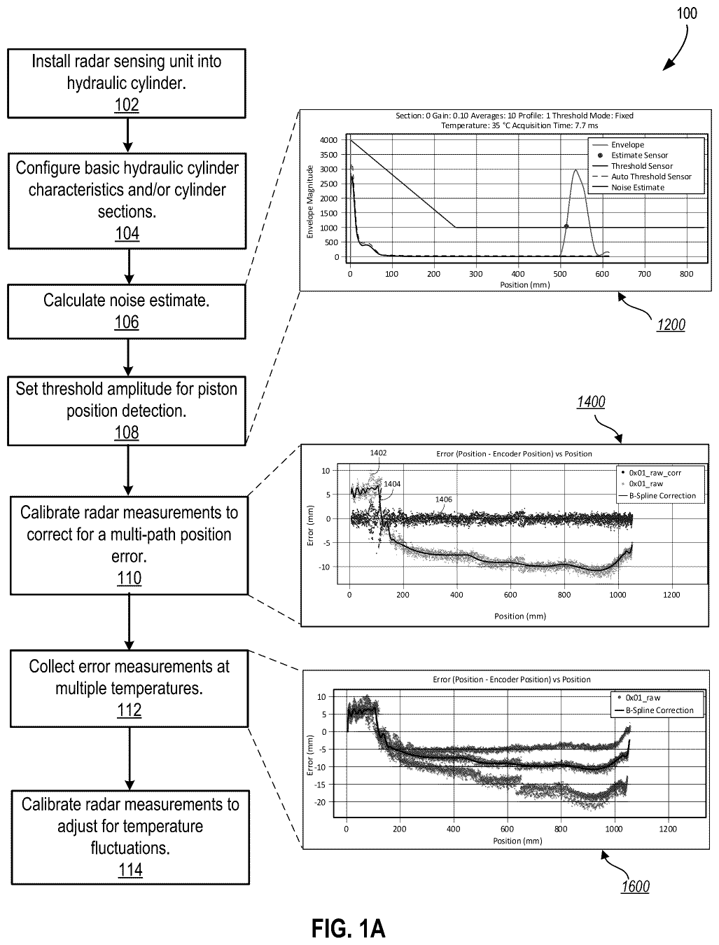

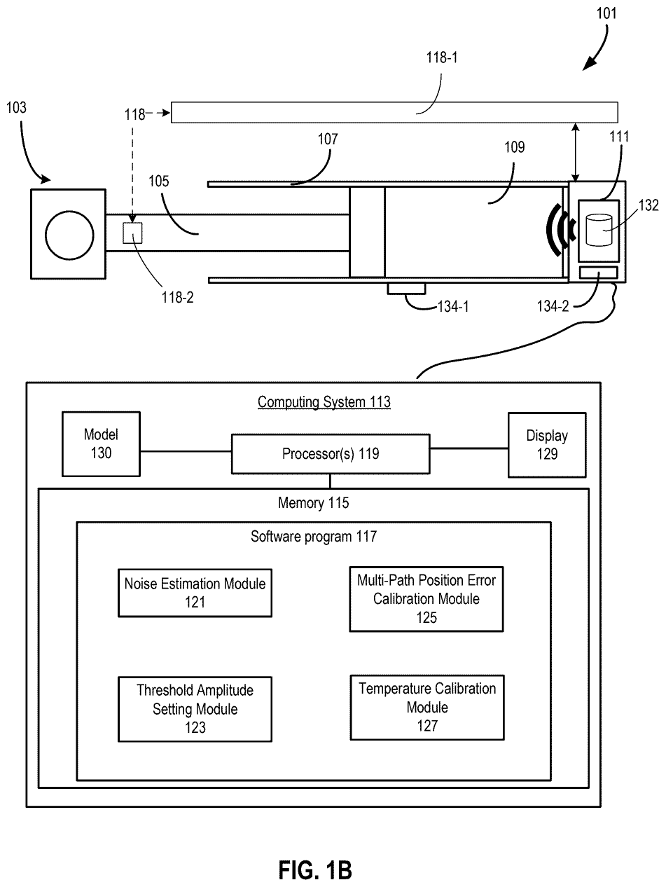

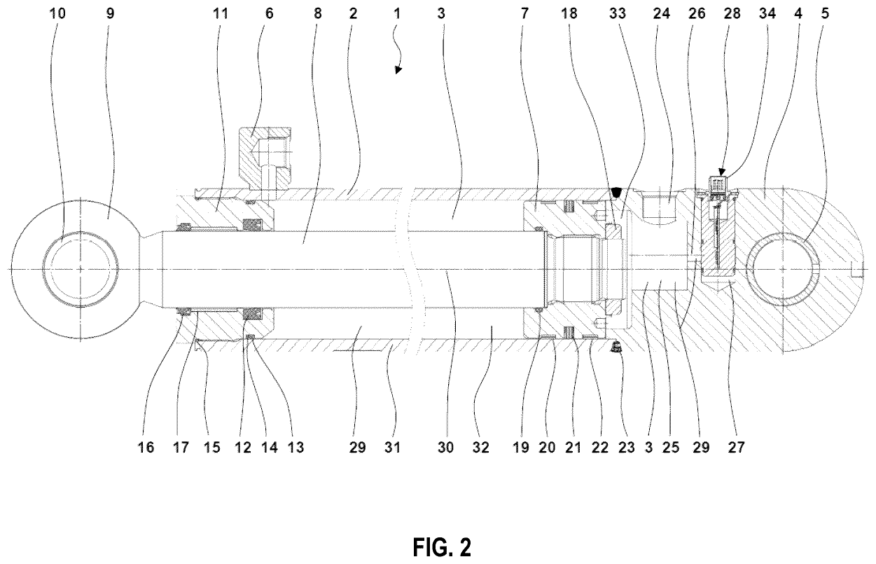

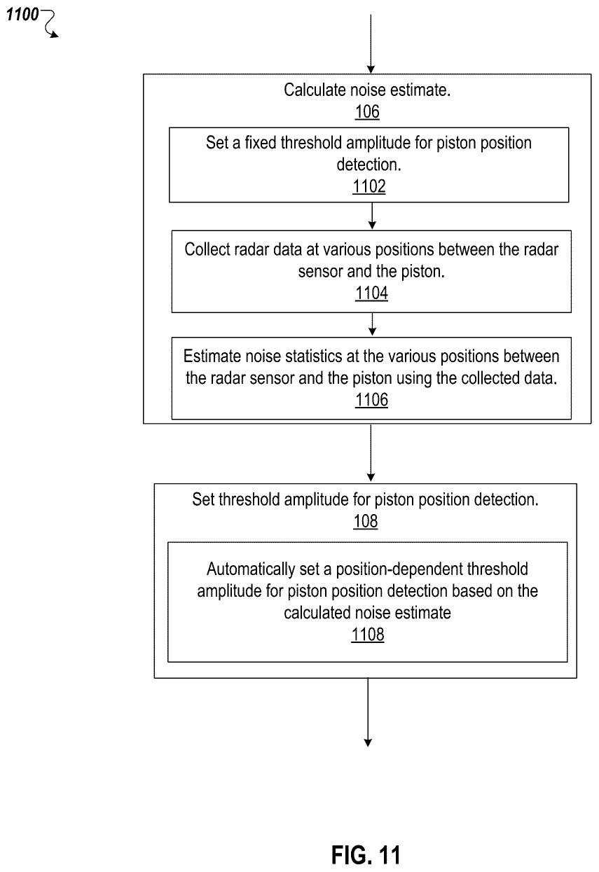

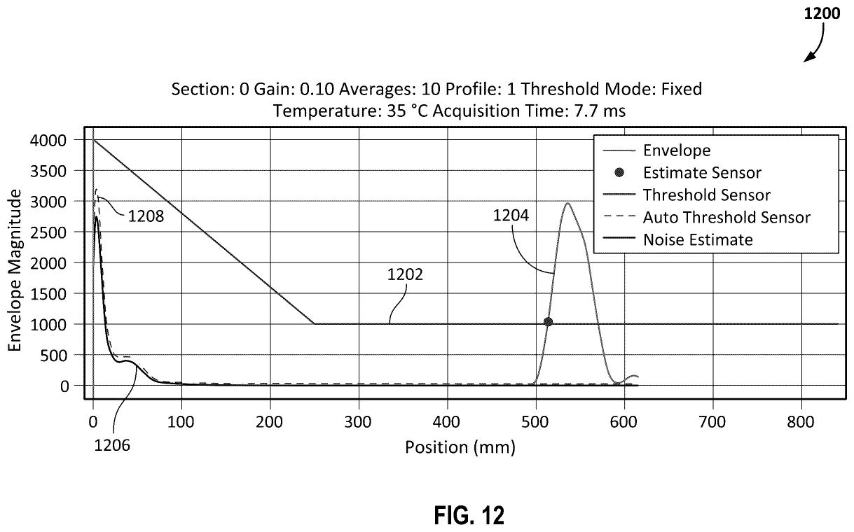

FIG. 1A illustrates a process 100 for calibrating a radar sensor included in a piston and cylinder unit (e.g., piston and cylinder unit 103 shown in FIG. 1B, piston and cylinder unit 1 shown in FIGS. 2-9, piston and cylinder unit 1001 shown in FIGS. 10A-10B, etc.), and FIG. 1B shows a system 101 configured to execute operations of the process 100. The piston and cylinder unit, for example, can make up a hydraulic cylinder system, such as those used in industrial equipment including construction vehicles, manufacturing machinery, elevators, etc. As shown in FIG. 1B, the piston and cylinder unit 103 can include a piston 105 configured to fit within and move longitudinally within a cylinder 107 that contains hydraulic fluid 109. A radar sensor 111 included in the piston and cylinder unit can be configured to emit a radar signal within the hydraulic cylinder (e.g., through the hydraulic fluid 109 contained within the cylinder 107), and receive a reflected signal indicative of a position of the piston 105 within the hydraulic cylinder. Based on the received signals at the radar sensor 111, a position and/or velocity of the piston 105 within the cylinder 107 can be measured. Additional examples of piston and cylinder units with radar sensors that can be calibrated using the process 100 are shown and described in further detail herein, for example, in relation to FIGS. 2-9 and FIGS. 10A-10B.

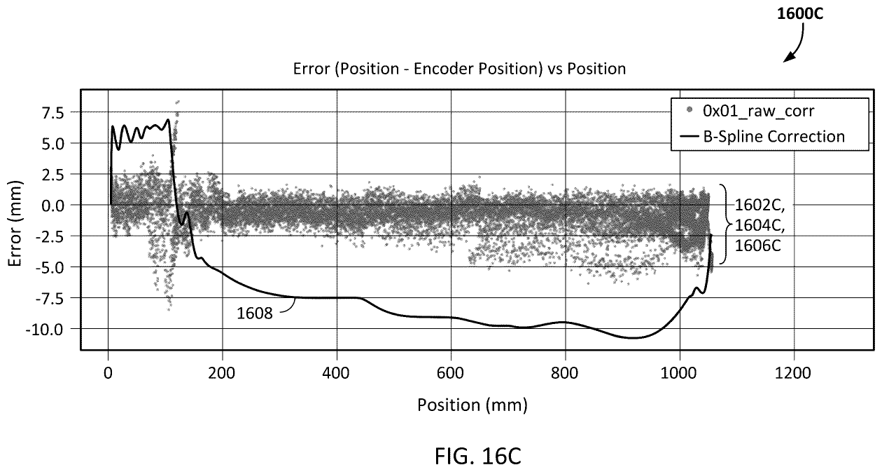

As shown in FIG. 1B, the system 101 can further include a computing system 113 that is connected (e.g., wirelessly or via a wired connection) to the piston and cylinder unit 103. For example, the computing system 113 can be implemented using one or more of the computing devices and mobile computing devices described in relation to FIG. 16 below. In the example shown in FIG. 1B, the computing system 113 includes a memory 115 connected to one or more processors 119. The memory 115 stores a software program 117, which can be executed by the one or more processors 119 to perform one or more operations of the process 100. For example, the software program can include one or more modules including a noise estimation module 121, a threshold amplitude setting module 123, a multi-path position error calibration module 125, and a temperature calibration module 127—the functions of which are described in further detail herein. In some implementations, the computing system 113 also includes a display 129, which can present a graphic user interface to a user, for example, to display outputs associated with the executed software program 117 and/or to receive user inputs that can be utilized by the software program 117.

As described above, the radar measurements of a piston position obtained by a radar sensing unit can be influenced by a variety of factors including the geometry and size of the piston and cylinder unit, a material of the piston and cylinder unit, a composition of the fluid within the cylinder, radar chip characteristics, attenuation of the radar signal within the cylinder, temperature of the fluid within the cylinder, etc. Thus, the process 100 can be advantageous for improving the accuracy and precision of piston position measurements by enabling various types of calibration including calibration for noise associated with the radar sensor, piston position calibration, and temperature calibration.

Operations of the process 100 include installing a radar sensing unit into a hydraulic cylinder (102). For example, as shown in FIG. 1B, the radar sensing unit can include a radar sensor 111 and can be installed into the cylinder 107. Other examples of piston and cylinder units with radar sensing units are described and shown below with respect to FIGS. 2-9 and FIGS. 10A-10B.

Operations of the process 100 also include configuring basic hydraulic cylinder characteristics and/or cylinder sections (104). Cylinder sections can refer to portions of the cylinder, e.g., locations within the hydraulic cylinder. Configuring the basic hydraulic cylinder characteristics can include, for example, specifying, in a software program (e.g., software program 117), one or more calibration parameters such as a size (e.g., length), shape, and/or material of the piston and cylinder unit 103. In some cases, the one or more calibration parameters can be entered by a user via a graphic user interface presented on the display 129. The one or more calibration parameters can then be used as inputs to a calibration algorithm implemented by the software program 117, as described herein. For example, a cylinder length entered by the user via the graphic user interface can be used by the system 101 to configure the measurements from the radar sensor 111 accordingly and output measurements ranging from 0 mm to the cylinder length after calibration. In addition, configuring the cylinder sections can include defining, for use by the software program 117, one or more sections along the longitudinal axis of the cylinder 107 at various distances from the radar sensing unit.

Each of these cylinder sections may be defined to have corresponding measurement parameters such as a receiver gain associated with the radar sensor 111 of the radar sensing unit and/or a number of measurements averaged by the radar sensor 111 to determine the piston position. Defining various sections of the cylinder 107 can have the advantage of reducing the acquisition time of measurements since data only needs to be acquired for the pre-defined section of the cylinder 107 where the piston 105 is expected to be located. Defining various sections of the cylinder 107 for the software program 117 can also have the advantage of enabling the software program 117 to counteract the attenuation of the reflected signal received at the radar sensing unit (e.g., by using varying receiver gains at different sections of the cylinder 107, using hardware averaging when the piston 105 is farther away from the radar sensor 111, etc.).

In some implementations, the radar sensor can be configured to acquire, e.g., capture, radar detections associated with a particular cylinder section from multiple cylinder sections of the hydraulic cylinder. For example, the radar sensor can process the return signals (and their corresponding detections) associated with the particular cylinder section, e.g., selectively processing a subset of data, and discard data associated with other cylinder sections. In some implementations, the radar sensor can be configured to transmit signals associated with detecting objects, e.g., the piston, in a particular cylinder section, thereby receiving and processing signals for the particular cylinder section without generating and/or processing signals for the other cylinder sections.

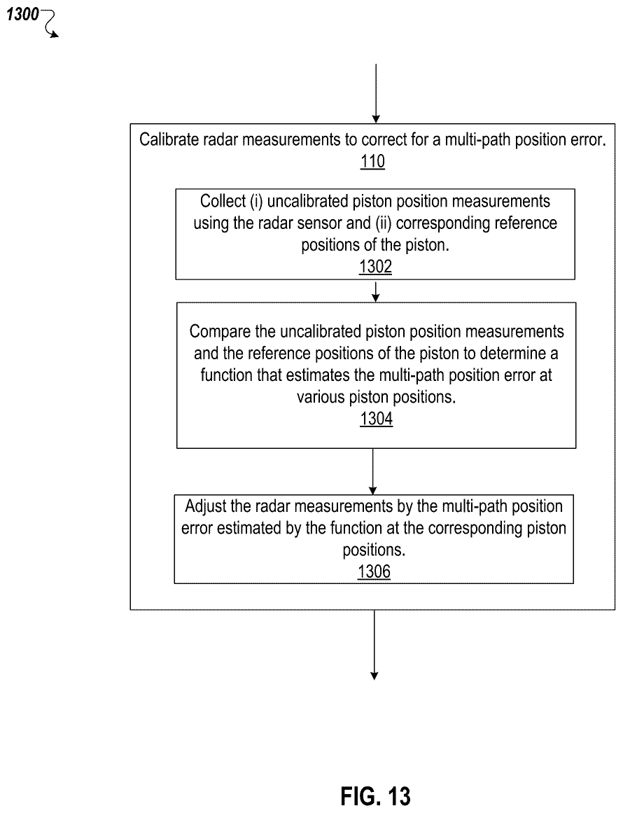

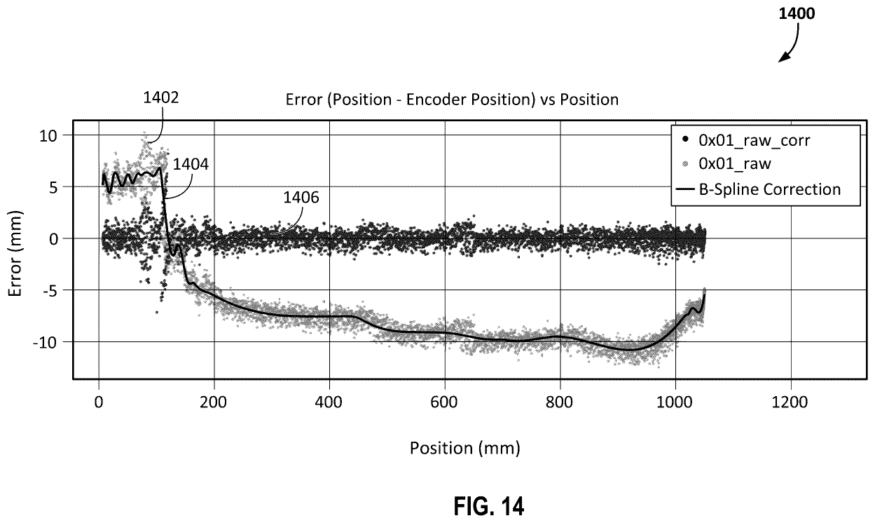

Next, the process 100 includes calculating a noise estimate (106) and then setting a threshold amplitude for piston position detection (108). The noise estimate calculation can be performed, for example, by the noise estimation module 121 while the threshold amplitude setting can be performed by the threshold amplitude setting module 123. The operations 106 and 108 are shown in greater detail in FIG. 11 with a corresponding example plot 1200 shown in FIG. 12. Referring to FIG. 11, the process 1100 shows that calculating the noise estimate (106) can include setting a fixed threshold amplitude for piston position detection (1102). The fixed threshold amplitude represents a minimum magnitude of an envelope signal (corresponding to the reflected signals received at the radar sensor), above which the piston is determined to have been detected. The fixed threshold amplitude need not be finely tuned, but should be configured such that it cleanly intersects with the envelope signal to yield an indication of the approximate position of the piston within the cylinder. For example, referring to the plot 1200 shown in FIG. 12, the fixed threshold amplitude is represented by trace 1202, which has been set at a level to intersect with the envelope signal 1204 (indicative of the approximate position of the piston within the cylinder).

Referring back to FIG. 11, the process 1100 shows that calculating the noise estimate (106) further includes the operations 1104 and 1106. The operation 1104 includes collecting radar data at various positions between the radar sensor and the piston such that the collected data is representative of a noise signal at each position. The operation 1106 includes estimating noise statistics (e.g., a mean and standard deviation of the noise) at the various positions between the radar sensor and the piston using the collected data. In some implementations, the piston can be moved to a maximum position (e.g., farthest from the radar sensor) while the radar data is collected. However, as shown in FIG. 12, beyond a certain distance from the radar sensor, the noise estimates (represented by the trace 1206) do not change substantially. Therefore, in some implementations, (i) the piston need not necessarily be moved all the way to the maximum position while the radar data is collected, and (ii) it may not be necessary to collect data for the entire length of the cylinder.

Once a noise estimate has been calculated (106), the process 100 can then include setting a threshold amplitude for piston position detection (108). As described above, the threshold amplitude set at operation 108 can be set by the threshold amplitude setting module 123 and can be a position-dependent threshold amplitude (compared to the fixed threshold amplitude described above in relation to operation 1102). As shown in FIG. 11, the process 1100 shows that setting the threshold amplitude for piston position detection (108) can include automatically setting a position-dependent threshold amplitude for piston position detection based on the calculated noise estimate (1108). For example, in some implementations, the position-dependent threshold amplitude can be automatically set to be a certain number of standard deviations above a mean value of the noise estimate (e.g., 2 standard deviations above the mean, 3 standard deviations above the mean, 5 standard deviations above the mean, 10 standard deviations above the mean, etc.). Referring to FIG. 12, the automatically set position-dependent threshold amplitude for piston position detection is represented by the trace 1208. Like the fixed threshold amplitude, the position-dependent threshold amplitude represents a minimum magnitude of an envelope signal (corresponding to the reflected signals received at the radar sensor), above which the piston is determined to have been detected. However, unlike the fixed threshold amplitude described above, the position-dependent threshold amplitude is much more finely tuned to prevent false positive and false negative detections of the piston within the cylinder.

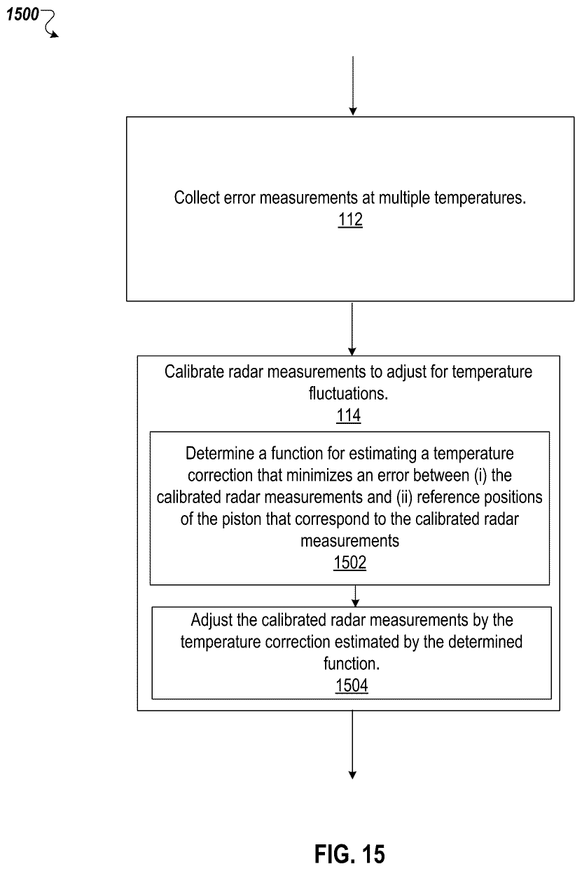

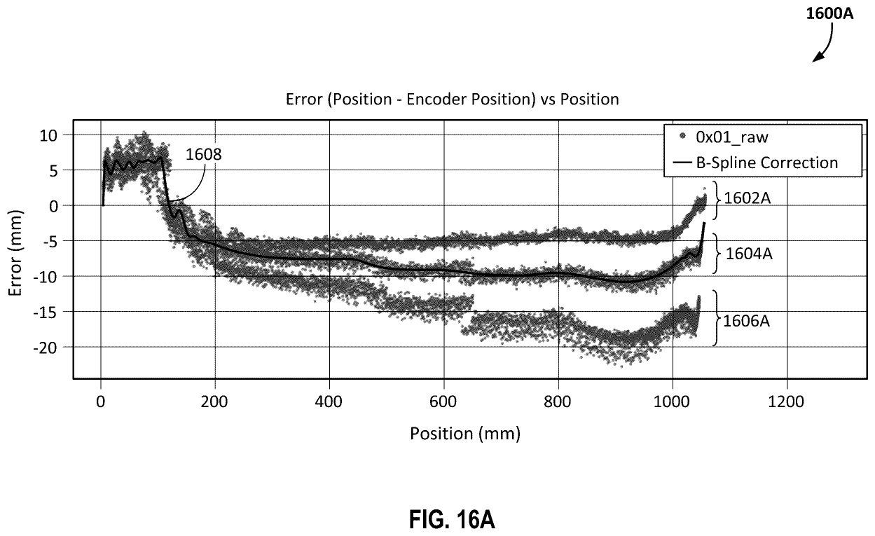

Referring again to FIG. 1A, after setting the threshold amplitude for piston position detection (108), the process 100 includes calibrating radar measurements to correct for a multi-path position error (110). In some implementations, the operation 110 can be performed by the multi-path position error calibration module 125. The operation 110 is shown in greater detail in FIG. 13 with a corresponding example plot 1400 shown in FIG. 14. Referring to FIG. 13, the process 1300 shows that calibrating radar measurements to correct for a multi-path position error (110) can include operations 1302, 1304, and 1306. The operation 1302 of the process 1300 includes collecting (i) uncalibrated piston position measurements using the radar sensor and (ii) corresponding reference positions of the piston. The operation 1304 of the process 1300 includes comparing the uncalibrated piston position measurements and the reference positions of the piston to determine a function that estimates the multi-path position error at various piston positions. For example, the piston can be slowly moved from a maximum position (e.g., farthest from the radar sensor) to a minimum position (e.g., closest to the radar sensor) and back to the maximum position while collecting piston position measurements using the radar sensor. Meanwhile, the reference positions of the piston throughout this movement can be determined by a reference position sensor such as a glass scale encoder coupled to the piston and cylinder unit. The multi-path position error can be determined by calculating the difference between (i) the radar measurements of the piston position and (ii) the reference positions of the piston.

In some implementations, the multi-path position error can be reduced by reducing an error between raw position data p_{R} and reference position data p_{REF} for a piston in the hydraulic cylinder. For example, the raw position p_{R} of a piston can be collected by detecting a leading edge of a signal envelope of a return signal, e.g., a signal returned from illuminating the piston with one or more radar signals. A reference position p_{REF} of the piston can be determined by a reference sensor that is known to have high accuracy, e.g., a glass scale encoder or other gold standard, that is configured to measure the relative position of the piston along a length of the hydraulic cylinder. For example, and referring to FIG. 1B, the piston and cylinder unit 103 can include a reference sensor 118 configured to collect data indicative of position of the piston 105. The reference sensor 118 can include one or more reference sensor components 118-1 and 118-2 that can be part of, mounted onto, coupled to, etc. to the piston and cylinder unit 103. For example, the reference sensor 118 can be a glass scale encoder 118 with a glass scale 118-1 and a readhead 118-2 to capture reference sensor measurements, e.g., a light source and/or photodetector. Although FIG. 1B depicts two reference sensor components, the reference sensor 118 can include any number of components.

The multi-path position error e_{M} can be determined as a difference between a raw position measurement p_{R} of the piston captured by radar sensor 111 and the reference position measurement p_{REF} of the piston captured by the reference sensor 118, such as described in reference to equation (1) below:

$${e}_{M} = {p}_{R} - {p}_{REF} \qquad ( 1 )$$

An example plot 1400 depicted in FIG. 14 depicts the multi-path position errors 1402 plotted relative to the radar measurements of the piston position to demonstrate a relationship between multi-path position error and piston position within the cylinder. FIG. 14 also includes a trace 1404 depicting a function estimating the multi-path position error at multiple piston positions, such as a B-spline curve fit to the multi-path position errors 1402. As shown, the plotted error varies as a function of the piston's position in the cylinder.

In some implementations, the multi-path position error can be represented in a compact form to smoothen the error between raw position and reference position measurements, such as in the form of multi-path position error data. The multi-path position error data can be stored in the radar sensor 111 and the radar sensor 111 can be configured to subtract the multi-path position error from raw position measurements captured by the radar sensor 111, e.g., while the radar sensor is operating. By storing the multi-path position error in the radar sensor 111, a position measurement of the piston can be determined with improved accuracy, e.g., by adjusting the measurement using the multi-path position error prior to transmitting the position measurement upstream, e.g., to devices connected the piston and cylinder unit 103. The multi-path position error can be represented by equation (2) below, where ƒ(p_{R}) is a function of raw position captured by the radar sensor 111 and residual error e

$${e}_{M} = {p}_{R} - {p}_{REF} = f ( {p}_{R} ) + e \qquad ( 2 )$$

A corrected position P_{C} of the piston captured by the radar sensor 110 can be represented by equation (3) below:

$${P}_{C} = {p}_{R} - f ( {p}_{R} ) \qquad ( 3 )$$

A function of the radar position sensor measurement of the radar sensor 111, e.g., ƒ(p_{R}), can be a polynomial, splines, rational functions, or another type of model. For example, a piecewise polynomial function such as a basis spline or B-spline can be used to capture a shape of the multi-path position error relative to the position of the piston in the hydraulic cylinder, e.g., a piston translating along a longitudinal axis of the cylinder body. An example B-spline function for representing the radar position sensor measurement of the radar sensor 111 is shown in equation (4) below, where q represents the order the B-spline, k represents the number of knots, and aⱼ is the j^{th} coefficient of the B-spline, e.g., ƒ(x), with basis functions B_{j,q}(x):

$$f ( x ) = {\sum }_{j = 1}^{q + k + 1} {a}_{j} {B}_{j , q} ( x ) \qquad ( 4 )$$

The basis function B_{j,q}(x) can be represented by equations (5)-(7) below:

$${B}_{j , q} ( x ) = \frac{x - {t}_{j}}{{t}_{j + q} - {t}_{j}} \qquad ( 5 )$$

$${B}_{j , q - 1} ( x ) + \frac{{t}_{j + q + 1} - x}{{t}_{j + q + 1} - {t}_{j + 1}} \qquad ( 6 )$$

$${B}_{j + 1 , q + 1} ( x ) if q > 0 ( {B}_{j + 1 , q + 1} ( x ) = 0 otherwise ) \qquad ( 7 )$$

Referring to the knots k of the B-spline, the knots at t₁, t₂ . . . tₖ represent increasing positions from one end of the cylinder, e.g., 0 millimeters, to another end of the cylinder, e.g., the full length of the cylinder length. Referring to FIG. 1B, the computing system 113 can include a model 130 trained to apply one or more algorithms to determine a number of knots for the B-spline functions, e.g., to avoid using too many knots (resulting in overfitting) or to avoid using too few knots (resulting in underfitting). For example, the model 130 can be trained to use an initial number of knots that are based on a length of the hydraulic cylinder, e.g., a number of equally spaced knots that subsect the length of the hydraulic cylinder. The model 130 can be trained to apply one or more penalized likelihood techniques (e.g., Ridge Regression, LASSO, Elastic Net, Smoothing Splines) to identify parameters that result in a sparse model with relatively few knots that provide an accurate estimate for multi-path position error. In some implementations, the model 130 can include multiple models and a model selection procedure can be performed by testing models with increasing regularization parameters. A model that increases, e.g., maximizes, a model selection criterion can be selected from multiple models.

As an example, the disclosed system can collect position data at N operating temperatures

$${T}_{C}^{i} , where i = 1 , … , N and N$$

is any non-negative number. The operating temperatures can be evenly spaced across a portion or entirety of an operating temperature range for by the radar sensor 111 and/or the hydraulic cylinder. For each operating temperature and cylinder section j, where j=1, . . . , K, a function (e.g., a B-Spline function)

$${f}_{i}^{j} ( x )$$

can be fit to the MPE data collected for each operating temperature and cylinder section. A total of N×K functions can be obtained during the calibration process. The parameters associated with determining the functions can be referred to as MPE calibration data, which can include the knot positions, the coefficients, the cylinder sections, and the associated calibration temperature of each function. The calibration data can be stored in the memory 132, e.g., non-volatile memory, of the radar sensor 111.

In some implementations (such as during operation), the MPE calibration data can be used to predict the MPE based on a current cylinder section, a raw position measurement of the piston in the hydraulic cylinder, and an operating temperature of the hydraulic cylinder. Examples of the operating temperature can include a temperature measurement captured by a temperature sensor, an operating temperature of the radar sensor, an operating temperature of the hydraulic cylinder, or some combination thereof.

Referring to FIG. 1B, a temperature sensor 134-1 and/or 134-2 can generate temperature measurements of the operating temperature T. Based on the temperature, the temperature sensors 134-1 and/or 134-2 can select the two closest calibration temperatures, such that

$${T}_{C}^{q} \leq T < {T}_{c}^{r} .$$

The radar sensor 111 can generate an initial estimated position and select a current cylinder section j based on the initial estimated position. A pair of functions for estimating the multi-path position error can be selected, e.g., the two closest B-Spline functions,

$${f}_{q}^{j} ( x ) and {f}_{r}^{j} ( x ) .$$

The selected functions, e.g., B-Splines, can be used to estimate the MPE associated with temperature T, such as by interpolating (e.g., linear, quadratic, cubic) of the functions based on the operating temperature. For example, equations (8) and (9) below demonstrates linear interpolation of two functions

$${f}_{q}^{j} ( x ) and {f}_{r}^{j} ( x )$$

with a coefficient α:

$$α = \frac{T - {T}_{C}^{q}}{{T}_{C}^{r} - {T}_{C}^{q}} \qquad ( 8 )$$

$$f ( x ) = ( 1 - α ) {f}_{q}^{j} ( x ) + α {f}_{r}^{j} ( x \qquad ( 9 )$$

The interpolated function represented by equation (9) can be used to estimate the corrected position, as shown in equation (10) below:

$${P}_{C} = {p}_{R} - f ( {p}_{R} ) \qquad ( 10 )$$

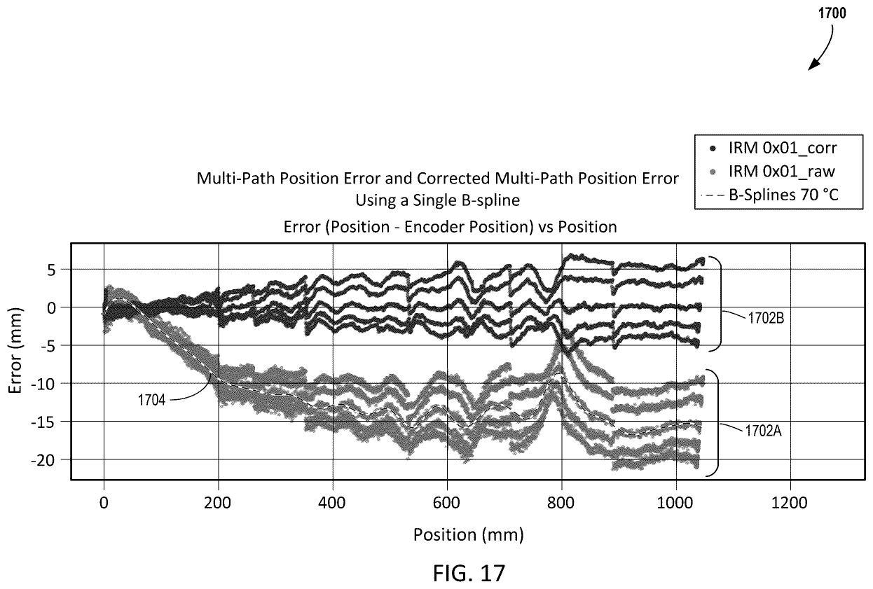

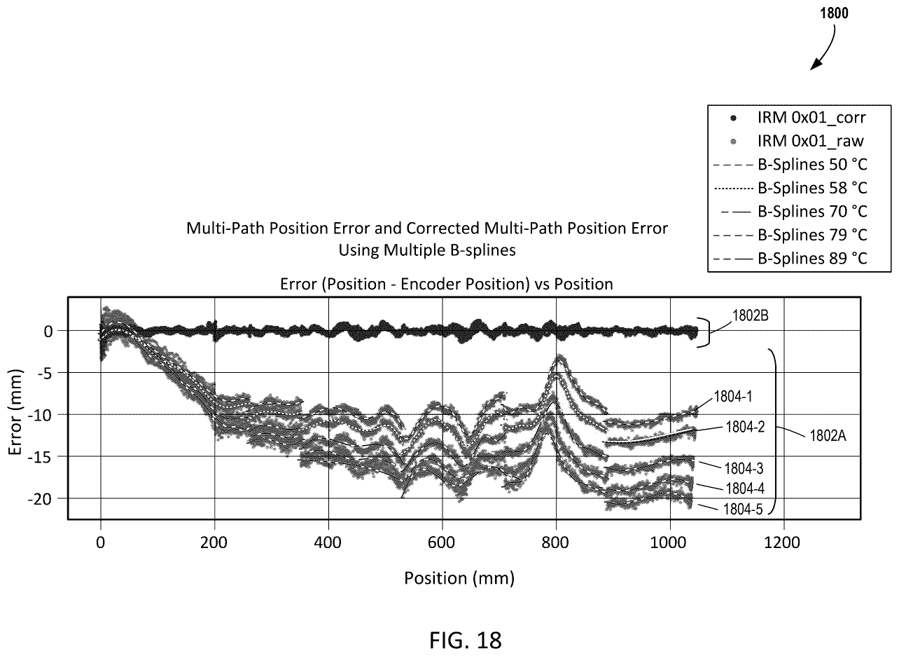

In some implementations, a single function may be used for estimating MPE, e.g., without interpolating two or more functions. For example, when the radar sensor, temperature sensor, and/or hydraulic cylinder is operating outside of a temperature range associated with the MPE calibration data, the radar sensor 111 can utilize a single function (e.g., a single B-spline function) and adjust the residual error using a linear model. As described in reference to FIGS. 17 and 18 below, a reduction or minimization of MPE represented by functions, e.g., a MPE derived from a single function compared to a MPE derived from multiple functions.

Referring to plot 1400 shown in FIG. 14, the multi-path position errors 1402 can be plotted against the radar measurements of the piston position to determine how the multi-path position error fluctuates depending on the positioning of the piston within the cylinder. A function that estimates the multi-path position error at various piston positions can be determined, for example, using a B-spline curve fit to the multi-path position errors 1402 (or by using any other function-fitting process). In FIG. 14, the B-spline curve fit of the multi-path position errors 1402 as a function of piston position is represented by the trace 1404.

At operation 1306 of the process 1300, radar measurements can be adjusted by the multi-path position error estimated by the function determined at operation 1304. For example, based on the radar measurement of the piston position, the estimated multi-path position error can be provided by the function represented by the B-spline 1404. The radar measurement can then be adjusted by this estimated multi-path position error to yield a more accurate value of the piston's true location within the cylinder. As shown in FIG. 14, after adjusting for multi-path position error using this technique, very little remaining error 1406 was observed between the adjusted radar measurements and the reference positions of the piston.

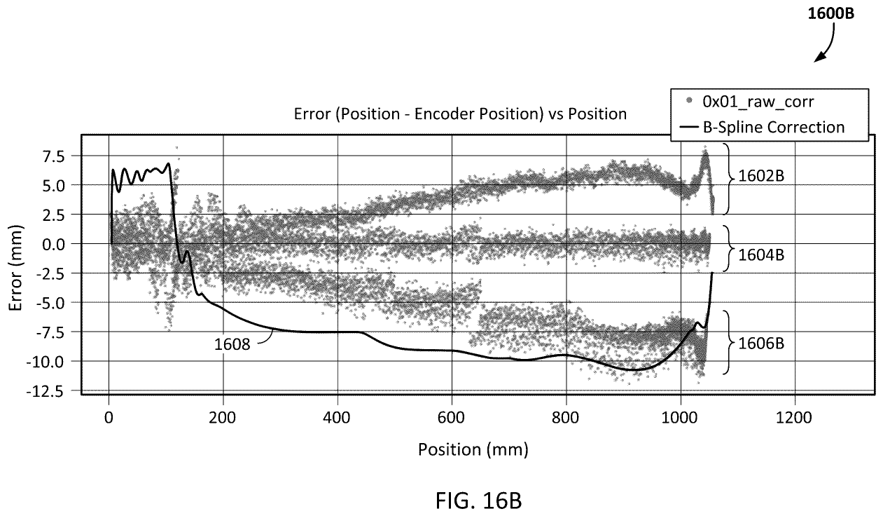

Referring back to FIG. 1A, after calibrating the radar measurements to correct for a multi-path position error (110), the process 100 includes collecting error measurements at multiple temperatures (112) and calibrating radar measurements to adjust for temperature fluctuations (114). In some implementations, the operations 112 and 114 can be performed by the temperature calibration module 127. The operations 112 and 114 are shown in greater detail in FIG. 15 with corresponding example plots 1600A-1600C shown in FIGS. 16A-16C, respectively.

As described above, the reflected signal received at a radar sensor can be dependent on a temperature within the hydraulic cylinder (e.g., the temperature of the hydraulic fluid within the hydraulic cylinder). In particular, the dielectric constant of the fluid is dependent on the temperature of the fluid, so fluctuations in temperature can alter the propagation velocity of the radar signal in the fluid and thus affect the estimated position of the piston within the hydraulic cylinder. Thus, it is important to calibrate for multi-path position error not only at a single temperature, but at a variety of operating temperatures.

At operation 112, error measurements (e.g., multi-path position errors) are collected at multiple temperatures. For example, plot 1600A of FIG. 16A shows the measured multi-path position errors plotted against radar measurements of the piston position for three different temperatures—32° C. (corresponding to points 1602A), 64° C. (corresponding to points 1604A), and 92° C. (corresponding to points 1606A). As seen in plot 1600A, the multi-path position errors are different depending on the temperature within the cylinder, with the magnitude of the errors steadily increasing as the temperature rises.

Implementing a similar curve fitting process as described above in relation to FIGS. 13 and 14, a function that estimates the multi-path position error at various piston positions can be determined for the points 1604A (corresponding to the piston position measurements collected at 64° C.). The resulting function is shown in FIG. 16A by trace 1608.

Next, the multi-path position error estimated by the function corresponding to trace 1608 can be used to adjust the radar measurements at all three temperatures (e.g., 32° C., 64° C. and 92° C.) using a similar process as described above in relation to operation 1306. Referring to FIG. 16B, a plot 1600B depicts the adjusted error for each radar measurement after this adjustment. The points 1602B correspond to the adjusted errors for the measurements collected at 32° C., the points 1604B correspond to the adjusted errors for the measurements collected at 64° C., and the points 1606B correspond to the adjusted errors for the measurements collected at 92° C. As expected, since the function corresponding to trace 1608 was determined using only measurements collected at 64° C. (e.g., points 1604A), the adjusted errors for measurements collected at 64° C. (e.g., points 1604B) are consistently close to zero. However, the adjusted errors for measurements collected at 32° C. (e.g., points 1602B) and the adjusted errors for measurements collected at 92° C. (e.g., points 1606B) generally have larger magnitudes, especially as the piston moves farther away from the radar sensor. These results demonstrate that performing a calibration for multi-path position error estimated at one temperature can be insufficient to account for radar measurements collected at other temperatures.

At operation 114 of the process 100, radar measurements can be calibrated to adjust for temperature fluctuations. As shown in FIG. 15, the process 1500 shows that the operation 114 can include determining a function for estimating a temperature correction that minimizes an error between (i) calibrated radar measurements and (ii) reference positions of the piston that correspond to the calibrated radar measurements (1502). For example, similar to the points shown in plot 1600B, the calibrated radar measurements can be radar measurements that have already been adjusted to account for a multi-path position error at a single temperature (e.g., 64° C.), but have not yet been calibrated for different temperatures. To further adjust for temperature fluctuations, the operation 1502 can include determining one or more coefficients corresponding to an approximation of the error between (i) the calibrated radar measurements and (ii) the reference positions of the piston that correspond to the calibrated radar measurements. For example, the approximation of the error can be a first-order or higher-order approximation of the residual errors in plot 1600B, which are largely attributable to fluctuations in the temperature within the piston and cylinder unit.

Referring again to FIG. 15, the process 1500 shows that after determining the one or more coefficients, the operation 114 can further include adjusting the calibrated radar measurements by the temperature correction estimated by the determined function (1504). For example, the radar measurements (which have already been calibrated for a multi-path position error at a single temperature) can be further adjusted by the temperature correction estimated by the function determined at operation 1502 to yield a more accurate value of the piston's true location within the cylinder.

Referring to FIG. 16C, plot 1600C shows the adjusted errors for each radar measurement after applying the temperature calibration corresponding to operation 114 of the process 100. The points 1602C correspond to the temperature correction adjusted errors for the measurements collected at 32° C., the points 1604C correspond to the temperature correction adjusted errors for the measurements collected at 64° C., and the points 1606C correspond to the temperature correction adjusted errors for the measurements collected at 92° C. Compared to the points 1602B, 1604B, and 1606B in plot 1600B, after performing temperature calibration, the error for all of the points 1602C, 1604C, and 1606C are much closer to zero, and no substantial differences in error magnitudes are observable between measurements collected at different temperatures. Thus, it has been shown that using the techniques described herein, radar measurements can be calibrated to derive accurate piston position measurements at a wide range of temperatures.

Referring to FIG. 17, the plot 1700 depicts an initial multi-path position error and a corrected multi-path position error using multi-path position error derived from a single function, e.g., a single B-spline. The plot 1700 shows multi-path position errors 1702A that can be plotted against the radar measurements of the piston position to determine how the multi-path position error fluctuates depending on the positioning of the piston within the cylinder. A function that estimates the multi-path position error at various piston positions can be determined, for example, using a B-spline curve fit to the multi-path position errors 1702A (or by using any other function-fitting process).

In FIG. 17, the curve fit (e.g., B-spline) of the multi-path position errors 1702A as a function of piston position is represented by the trace 1704. The plot 1700 also shows corrected multi-path position errors 1702B derived from a function associated with a particular temperature, e.g., 70 degrees Celsius. The temperature can represent a temperature measurement of the hydraulic fluid in the hydraulic cylinder, a temperature measurement from a sensor mounted on a cylinder body (and/or another component) of the hydraulic cylinder, a measurement associated with an operating temperature of the hydraulic cylinder, etc.

The corrected multi-path position errors 1702B are also plotted against the radar measurements of the piston position to determine how the multi-path position error fluctuates depending on the positioning of the piston within the cylinder, but account for temperature as a correction factor, e.g., temperature corrected. Thus, the plot 1700 shows the corrected multi-path position errors 1702B having a lower magnitude and a smaller range of errors compared to the multi-path position errors 1702A.

Referring to FIG. 18, the plot 1800 depicts an initial multi-path position error and a corrected multi-path position error using multi-path position error derived from multiple functions, e.g., multiple B-splines. The plot 1800 shows multi-path position errors 1802A that can be plotted against the radar measurements of the piston position to determine how the multi-path position error fluctuates depending on the positioning of the piston within the cylinder. The plot 1800 shows multiple functions to estimate the multi-path position error at various piston positions. Each function is associated with a different temperature, e.g., each function can be a B-spline curve fit to the multi-path position errors 1802A (or by using any other function-fitting process).

In FIG. 18, the curve fit (e.g., B-spline) of the multi-path position errors 1802A as a function of piston position is represented by traces 1804-1 through 1804-5 (collectively “traces 1804”). Each of the traces plots a function associated with a temperature. Trace 1804-1 is a B-spline associated with a temperature of 50 degrees Celsius. Trace 1804-2 is a B-spline associated with a temperature of 58 degrees Celsius. Trace 1804-3 is a B-spline associated with a temperature of 70 degrees Celsius. Trace 1804-4 is a B-spline associated with a temperature of 79 degrees Celsius. Trace 1804-5 is a B-spline associated with a temperature of 89 degrees Celsius.

The plot 1800 also shows corrected multi-path position errors 1802B derived from a function associated with interpolation of multiple functions, e.g., multiple B-splines, that can be based on a temperature, e.g., a temperature sensor measurement. The corrected multi-path position errors 1802B are also plotted against the radar measurements of the piston position to determine how the multi-path position error fluctuates depending on the positioning of the piston within the cylinder, but account for temperature as a correction factor, e.g., temperature corrected. Thus, the plot 1800 shows the corrected multi-path position errors 1802B having a lower magnitude and a smaller range of errors compared to the multi-path position errors 1802A, and a smaller error compared to the multi-path position errors 1702A and the corrected multi-path position errors 1702B described in reference to FIG. 17 above.

Putting together all of the elements of the process 100, it is possible to achieve accurate piston position measurements that account for several major sources of measurement error including noise associated with the radar sensor, multi-path position error, and temperature fluctuation within the cylinder. It is possible, however, to modify the process 100, for example, by implementing only a subset of the operations described herein to account for only a subset of the various sources of error. For example, in some implementations, a noise estimate need not be calculated (at operation 106) before setting a threshold amplitude for piston position detection (at operation 108). In some implementations, calibration for multi-path position error (e.g., at operation 110) can be optional. And in still other implementations, temperature calibration (e.g., at operations 112 and 114) can be optional.

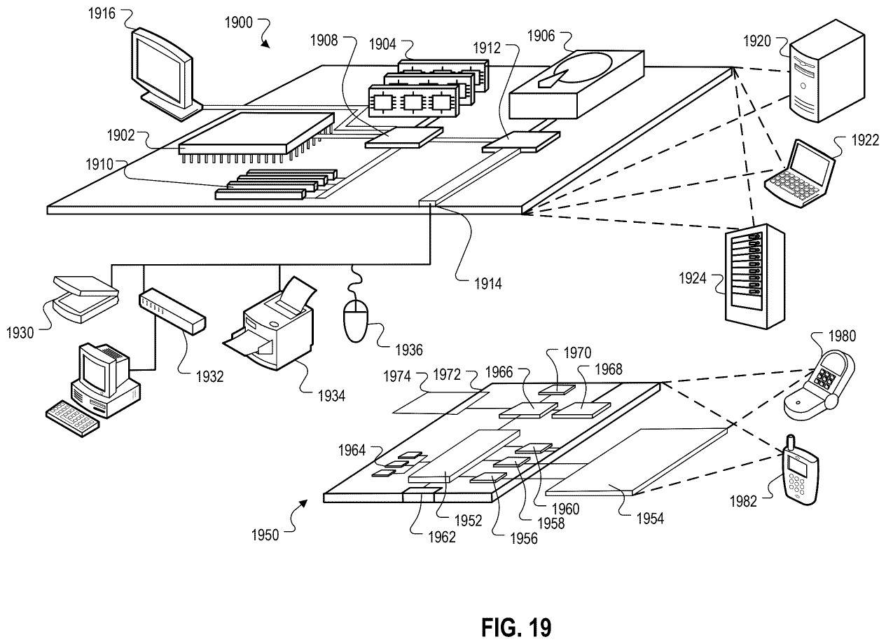

As described above, various steps of the process 100 and sub-processes described in this document can be performed by computing devices configured to execute software. In general, any software used to perform these processes can be performed using one or more processors disposed at the piston and cylinder unit itself (e.g., as part of the radar sensing unit), at one or more external computing devices that communicate with the radar sensing unit (e.g., over a data bus such as a CAN bus), or both. Examples of computing devices that can implement such software are described in further detail in relation to FIG. 19 below.

Examples of pistons and cylinder units are described in U.S. Pat. No. 11,378,107, U.S. PG Publication No. US 2022/0057477 A1, and EP 4 246 001 A1 which are incorporated herein by reference in their entirety. Such pistons and cylinder units can be calibrated using the techniques described in this document. For example, FIGS. 2-9 illustrate different views of illustrative embodiments of a piston and cylinder unit 1. FIGS. 10A-10B illustrate different views of yet another embodiment of a piston and cylinder unit 1001.

An example piston and cylinder unit is described in the publication DE 10 2019 122 121 A1. This piston and cylinder unit 1 (sometimes referred to herein as “piston-cylinder unit” 1) is shown in FIG. 2. In FIG. 2, it is shown by means of break lines that the piston-cylinder unit 1 can actually be longer and that only part of the piston-cylinder unit 1 is shown. The piston-cylinder unit 1 has a cylinder 2 with a cylinder tube 31, an interior 3 and a cylinder head 4. The cylinder tube 31 is connected to the cylinder head 4 via a weld seam 23. A bearing bush 5 is arranged in the area of the cylinder head 4. In DE 10 2019 122 121 A1, the piston-cylinder unit 1 is a hydraulic piston-cylinder unit, so the interior 3 is filled with a hydraulic fluid 29, in particular oil. For this purpose, the cylinder 2 has a connection 6 and a connection 24. A hydraulic circuit, not shown here, with a hydraulic pump and changeover valves is connected to the connections 6, 24. The connections 6, 24 each open into an associated pressure chamber 32, 33. The pressure chambers 32, 33 are formed in the interior 3 and separated from one another by a piston 7. The piston 7 can be moved along the longitudinal central axis 30 of the cylinder 2 while sealing the pressure chambers 32, 33. Depending on the pressure generated by the hydraulic circuit at the connections 6, 24, an actuating force can be generated hydraulically in both directions along the longitudinal central axis 30, which acts on the piston 7, and thereby generates movement of the piston 7 and a change in the volume of the pressure chambers 32, 33.

FIG. 2 shows the position of the piston 7 moved all the way to the right, in a fully retracted position of the piston-cylinder unit 1. The piston 7 is connected to a piston rod 8, at the outer end of which a piston rod eye 9 is arranged. The piston rod eye 9 also has a bearing bush 10. The bearing bushes 5, 10 serve to link the piston-cylinder unit 1 to parts of a work machine that are to be moved relative to one another by means of the piston-cylinder unit 1 and/or on which the piston-cylinder unit 1 exerts a force. The piston rod 8 is mounted in a translationally movable manner in the axial direction along the longitudinal central axis 30 by means of a guide bushing 11. A rod seal 12, an O-ring 13 and a support ring 14 are provided for support and sealing. At the other axial end of the guide bushing 11, another O-ring 15, a wiper 16 and a plain bearing 17 are arranged. The piston 7 is arranged non-rotatably on the piston rod 8 and secured by means of a lock nut 18. Furthermore, an O-ring 19, a piston guide ring 20, a piston seal 21 and a further piston guide ring 22 are arranged on the piston 7. In this way, the piston 7 is mounted together with the piston rod 8 and the piston rod eye 9 in a translationally reciprocating and sealing manner in the cylinder tube 31 of the cylinder 2. A partial chamber 25 of the pressure chamber 33 in the cylinder head 4 adjoins the part of the pressure chamber 33 which is delimited by the cylinder tube 31. The partial chamber 25 is connected to the connection 24. An axially extending sensor signal channel 26 opens into this partial chamber 25. The sensor signal channel 26 is also part of the pressure chamber 33 and is therefore filled with the hydraulic fluid. The sensor signal channel 26 is in turn connected to a transverse bore 27 which extends radially to the longitudinal central axis 30 in the cylinder head 4. The transverse bore 27 extends to the outer surface of the cylinder head 4 and can be connected to the environment by means of a compensating bore (not shown).

A piston movement sensor 28 (also referred to as a piston position detection unit 28) is arranged in the transverse bore 27. The piston movement sensor 28 is used to detect the axial position of the piston 7 in the cylinder 2 using high-frequency technology (e.g., using radar signals). For example, the piston movement sensor 28 can be a radar sensing unit (such as radar sensing unit 108) including one or more radar sensors and/or emitters configured to emit radar signals into the cylinder 2 and detect reflected radar signals. For this purpose, the piston movement sensor 28 sends out a high-frequency signal, which hits the end face of the piston 7 or the piston rod 8 through the sensor signal channel 26 and through the partial chamber 25 as well as through the pressure chamber 33 and, after reflection through this end face, returns to the piston movement sensor 28. The movement signal, in particular the path traveled by the end face, can then be determined from the reflected signal using high-frequency technology, in particular by evaluating the transit time. For example, an electronic unit connected to or included in the piston movement sensor 28 (including electronic components and software executed by these components) can carry out an evaluation of the reflected signals to determines the current position of the piston 7 along the longitudinal center axis 30. This determination can be conducted permanently, in defined time intervals or at specific points in time. In some implementations, the result or a command being associated with the result is transmitted to an electronic computing unit of the working machine connected therewith—a part of which is the piston and cylinder unit 1.

In the embodiment shown in FIG. 2, the piston movement sensor 28 is acted upon by the hydraulic fluid. A sensor housing of the piston movement sensor 28 has seals with which the piston movement sensor 28 is sealed axially on both sides of the sensor signal channel 26 so that the hydraulic fluid cannot escape from the pressure chamber 33 and via the transverse bore 27. The piston movement sensor 28 here has a connection plug 34, which is carried by the sensor housing of the piston movement sensor 28 and extends radially out of the cylinder head 4. For further details, reference is made to the publication DE 10 2019 122 121 A1, which is incorporated herein by reference in its entirety.

A further development of the piston-cylinder unit 1 is known from the publication EP 3 957 868 A1. It is proposed here that a collimator is arranged in the beam path for the high-frequency signal, which serves to increase the measurement accuracy of the piston movement sensor. A collimator is understood to be an optical device for generating a beam path with parallel beams from previously non-parallel beams from divergent sources. In a first direction of radiation from a transmitting unit of the piston movement sensor to the end face of the piston or the piston rod, the collimator converts the non-parallel rays emitted by the piston movement sensor into parallel rays, which are then also reflected in parallel from the end face of the piston or the piston rod. The reflected high-frequency beams are then bundled again by the collimator in the opposite second direction of radiation so that they can be received and evaluated by a receiving unit of the piston movement sensor. The collimator can also act as a type of filter that only or essentially focuses the high-frequency beams onto the piston movement sensor, which previously ran parallel to each other and to the longitudinal axis of the piston. This makes it possible to filter out high-frequency rays that do not come from the end piston crown surface, or at least not directly. Such undesirable rays are due to the fact that in reality the refraction of the collimator is not ideal, the rays are not emitted and received in an ideal point manner and the piston bottom surface is not ideally flat. The use of the collimator is intended to improve the signal-to-noise ratio. The collimator may include a dielectric lens. It is also possible to use several dielectric lenses or a Fresnel zone plate. The dielectric lens can have a convexly curved lens surface and/or be made of material from a dielectric plastic or a dielectric ceramic, polytetrafluoroethylene, polyethylene or polypropylene. The dielectric lens preferably has a dielectric constant (permittivity) greater than that of air and greater than that of the hydraulic fluid in the piston-cylinder assembly. The permittivity can be, for example, between 20% and 50% greater than that of the hydraulic fluid in the piston-cylinder unit. The permittivity difference and the curvature of the dielectric lens are coordinated with one another. The dielectric lens may have a planar-convex lens shape. The convex side of the lens can face the piston. On the other hand, the planar side then faces the piston movement sensor. The collimator may be formed by the sensor housing or may be structurally separated from the piston movement sensor itself and the sensor housing. The piston movement sensor can also be designed as a compact built-in cartridge that contains both the sensor and the evaluation electronics. The piston movement sensor is arranged in the cross bore with an orientation such that the longest dimension of the piston movement sensor extends in the direction of the longitudinal axis of the cross bore. Away from the sensor signal channel, beam deflection elements can be arranged on a bottom of the partial chamber in order to avoid falsification of the measurement results. The collimator can be arranged in the sensor signal channel. For further details, reference is made to the publication EP 3 957 868 A1, which is herein incorporated by reference in its entirety.

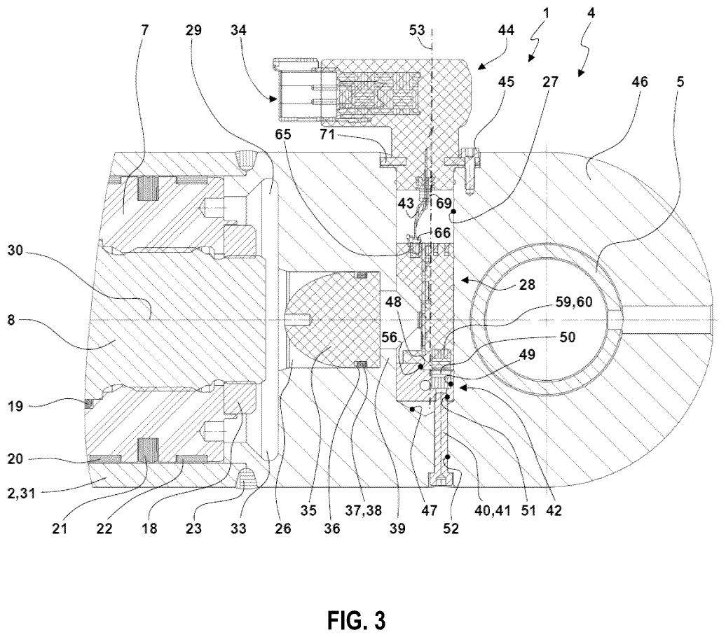

FIGS. 3-9 show another embodiment of a piston and cylinder unit 1, as described and shown in publication EP 4 246 001 A1, which is herein incorporated by reference in its entirety. The embodiment shown in FIGS. 3-9 has many similarities to the embodiment shown in FIG. 2, with similar elements labeled using similar reference numerals. Except where otherwise stated, what has been described about the embodiment shown in FIG. 2 is also applicable to the embodiment shown in FIGS. 3-9, and the further disclosure in the publications DE 10 2019 122 121 A1 and EP 3 957 868 A1 can also be used within the scope of these embodiments.

FIG. 3 shows a piston-cylinder unit 1 in the area of the cylinder head 4. A sensor signal channel 26 opens into the pressure chamber 33 of the piston-cylinder unit 1. A collimator 35 is arranged in the sensor signal channel 26. The collimator 35 has a flat end face on the side facing the piston movement sensor 28, which is oriented transversely to the longitudinal central axis 30. With regard to the longitudinal central axis 30, the collimator 35 is designed to be rotationally symmetrical on the other side. The collimator 35 can, for example, have a curved and in particular parabolic longitudinal section, as shown. The collimator 35 has an annular groove 36 in which a sealing element 37, here an O-ring 38, is arranged. The sealing element 37 ensures a hydraulic seal between the inner wall of the sensor signal channel 26 and the collimator 35. The sensor signal channel 26 has a circumferential shoulder 39. If the pressure chamber 33 is pressurized with hydraulic pressure, the pressure acts on the spherical end face facing the piston 7, applying a hydraulic force that presses the collimator 35 against the shoulder 39. This pressure of the collimator 35 on the shoulder 39 and/or the effect of the sealing element 37 can ensure that the transverse bore 27 is not exposed to hydraulic fluid and therefore no additional sealing measures need to be taken in the transverse bore 27. On the other hand, this seal makes it possible to dismantle the piston movement sensor 28 without hydraulic fluid being able to escape from the transverse bore 27.

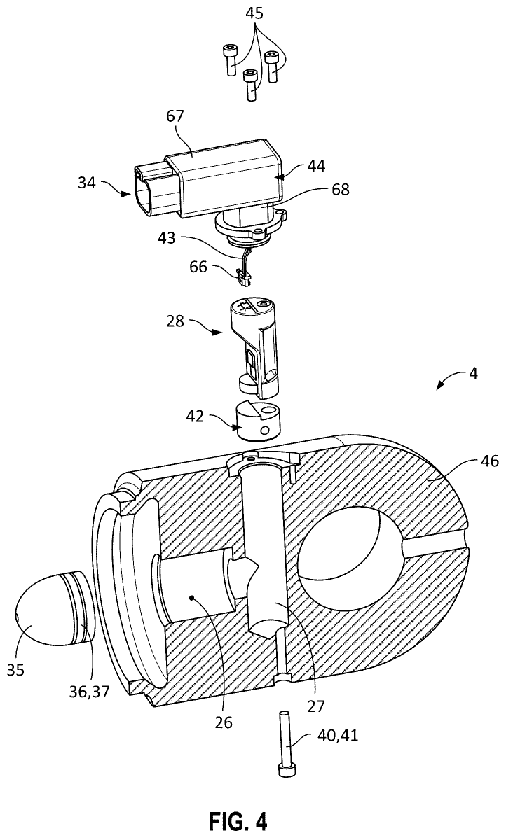

As shown in the exploded view in FIG. 4, a securing element 40 in the form of a screw 41, a positioning and/or alignment element 42, the piston movement sensor 28, a sensor cable 43 and a housing plug 44 are mounted in the transverse bore 27, the housing plug 44 being attached to the housing 46 of the cylinder head 4 via fastening screws 45.

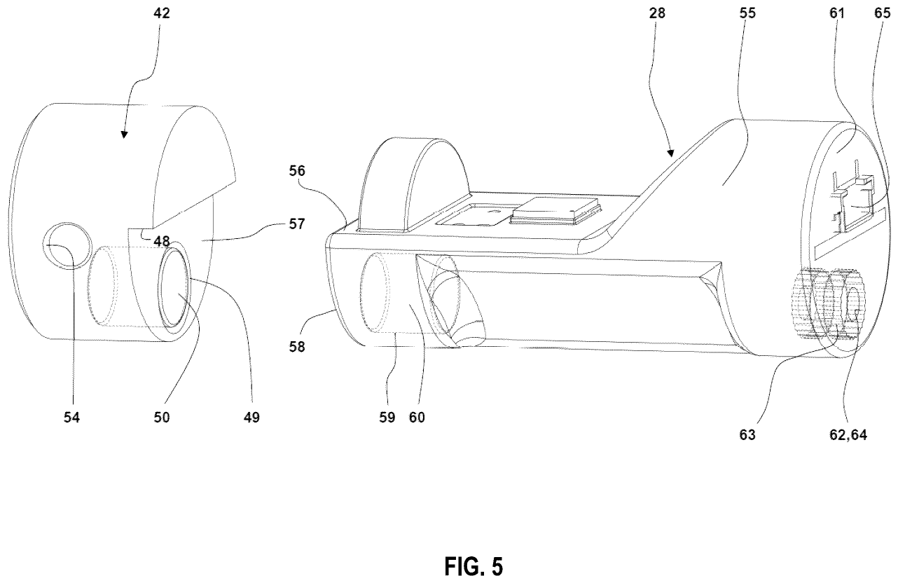

According to FIG. 5, the positioning and/or alignment element 42 is cylindrical with a diameter such that the positioning and/or alignment element 42 can be inserted precisely into the transverse bore 27. The underside of the positioning and/or alignment element 42 is flat for the exemplary embodiment shown. The underside of the positioning and/or alignment element 42 rests on a bottom 47 of the transverse bore 27, which is designed here as a blind hole.

On the side facing the piston movement sensor 28, the positioning and/or alignment element 42 is basically flat, but is designed with a step 48. On this side, the positioning and/or alignment element 42 has a (here cylindrical) receptacle 49, in which a permanent magnet 50 is accommodated, which can be glued to the receptacle 49 or pressed into it. The outer surface of the permanent magnet 50 is arranged flush with a partial surface of the end face of the positioning and/or alignment element 42 away from the step 48.

On the side facing away from the piston movement sensor 28, the positioning and/or alignment element 42 has an internal thread 51 arranged eccentrically to the longitudinal axis 53 of the transverse bore 27. In the aligned position of the positioning and/or alignment element 42 installed in the transverse bore 27, is an aligned internal thread 51 of the positioning and/or alignment element 42 with an eccentric bore 52 opening into the transverse bore 27. It is through this opening that the screw 41 extends from the outside through the housing 46 to fix the positioning and/or alignment element 42 in the correct position and orientation.

It is possible that the positioning and/or alignment element 42 also has a transverse bore 54, possibly with an internal thread. The transverse bore 54 is unlike the bore 52 shown in FIG. 3, which is oriented parallel to the longitudinal axis 53 of the transverse hole 27. Rather the transverse bore 54 is a hole provided perpendicularly to the plane of the drawing in which FIG. 3 is oriented. As an alternative to the attachment via the screw 41, the positioning and/or alignment element 42 can be attached via a screw which is perpendicular to the plane of the drawing in which FIG. 3 is oriented. The screw can extend through the housing 46 and is screwed in the inner end region to the transverse bore 54 of the positioning and/or alignment element 42.

The piston movement sensor 28 has a sensor housing 55, the external geometry of which is cylindrical with a diameter such that the sensor housing 55 can find a precise fit in the transverse bore 27. The sensor housing 55 also has recesses in which electronic components and the transmitting and/or receiving unit for the high-frequency signal are arranged.

On the side facing the positioning and/or alignment element 42, the sensor housing 55 has a step 56 which is designed to correspond to the step 48 of the positioning and/or alignment element 42. Away from the steps 48, 56, the positioning and/or alignment element 42 and the sensor housing 55 form contact surfaces 57, 58 which are oriented transversely to the longitudinal axis 53. The area in which these contact surfaces 57, 58 rest against one another in the direction of the longitudinal axis 53 defines the axial position of the piston movement sensor 28.

The steps 48, 56 further form a fit that prevents rotation about the longitudinal axis 53 and determines the orientation of the piston movement sensor 28. In the relative orientation determined by the steps 48, 56, a corresponding receptacle 59 with a permanent magnet 60 is provided on the sensor housing 55, aligned with the receptacle 49 and the permanent magnet 50 of the positioning and/or alignment element 42. The permanent magnet 60 is also fixed in the receptacle 59, for example by gluing or pressing it in. The magnetic force between the permanent magnets 50, 60 secures the system and thus the position and alignment between the positioning and/or alignment element 42 and the piston movement sensor 28.

On the side facing away from the positioning and/or alignment element 42, the sensor housing 55 has a flat end face 61. In the vicinity of the end face 61, the piston movement sensor 28 has an internal thread 62, which is formed here by a thread insert 63 injected into the sensor housing 55. The internal thread 62 forms a dismantling driver 64.

Furthermore, a plug receptacle 65 is provided in the end face 61, into which a plug 66 of a sensor cable 43 can be inserted. In some implementations, the format of the plug 66 and the plug receptacle 65 is a 5-pin pico-clasp connection (registered trademark).

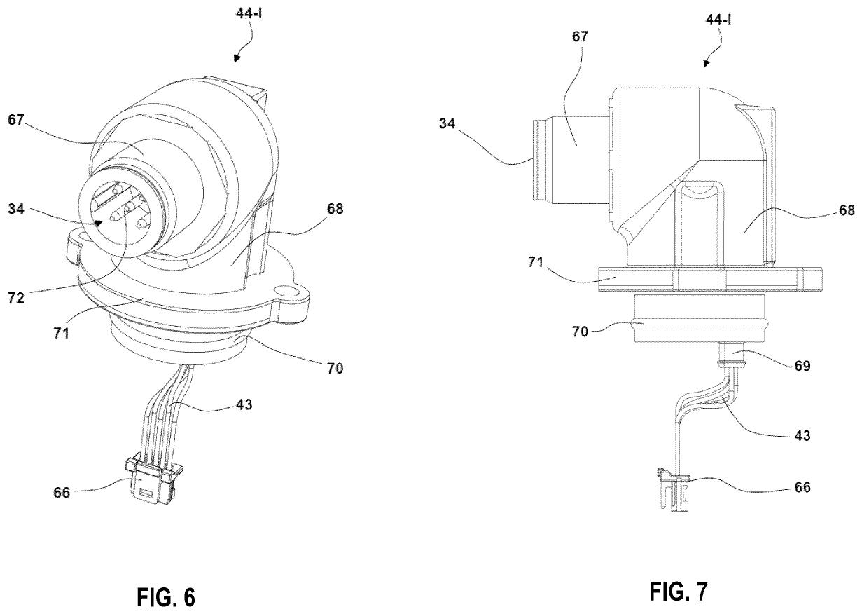

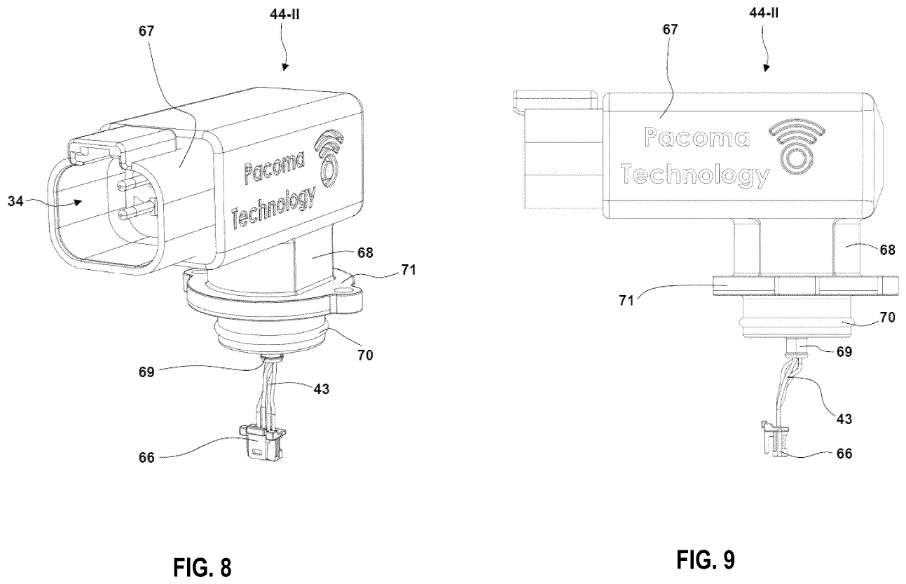

FIGS. 6 and 7 show a housing plug 44-I, where “I” here indicates that it is a housing plug of a first type (see the explanations for the first type above).

As can be seen in FIG. 7, the housing plug 44-I is L-shaped with a leg 67 and a leg 68 which is angled here at an angle of 90°. A plug receptacle is provided in the distal face of the leg 68, into which a plug 69 of the sensor cable 43 can be plugged in. In some implementations, both the plug receptacle and the plug 69 have the “pico-clasp” format.

When oriented coaxially to the longitudinal axis 53, the outer end region of the leg 68 extends into the transverse bore 27. The end region of the leg 68 can have a circumferential bead 70 or a sealing element. In the state inserted into the transverse bore 27, the bead 70 creates a frictional, elastically prestressed securing of the leg 68 in the transverse bore 27. In addition, in some implementations, a seal can be provided here.

In the exit area of the leg 68 from the housing 46 of the cylinder head 4, the leg 68 has a circumferential flange 71. The flange 71 is accommodated in a corresponding receptacle or recess in the housing 46. The flange 71 has through holes oriented parallel to the longitudinal axis 53, via which the flange 71 can be screwed to corresponding threaded holes in the housing 46. In some implementations, several holes are provided in the flange 71 and threaded holes in the housing 46, so that the housing plug 44-I can be screwed to the housing 46 in different orientations about the longitudinal axis 53.

The end region of the leg 67 forms the connecting plug 34, which enables a connecting cable to be connected. For the housing plug 44-I, the connecting plug 34 has, as shown in FIG. 6, five pins 72. In this configuration, the connection plug 34 is of the type “M12 5-pin”.

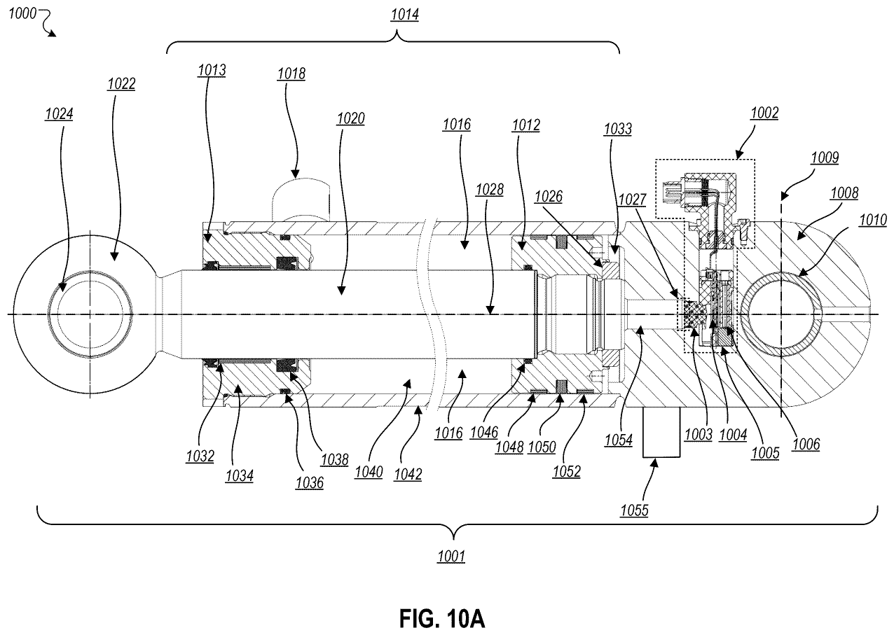

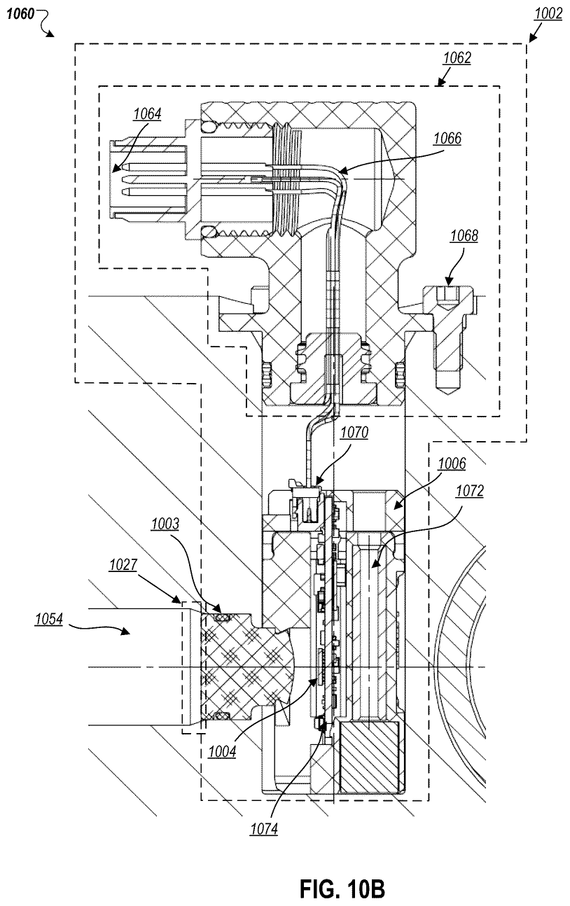

FIGS. 8 and 9 show a housing plug 44-II, where “II” here indicates that the housing plug is a housing plug of a second type, as described herein. Electronic components are integrated into the housing plug 44 in order to modify the transmitted signals from the plug 69 to the connecting plug 34.

The piston movement sensor 28 is used to directly measure the stroke of the piston 7 or the piston rod 8 within the piston-cylinder unit 1. The piston movement sensor 28 is preferably based on a non-contact measuring radar system in which the transit time between a transmitting unit and the end face of the piston 7 or the piston rod 8 and the reflected signal received at a receiving unit is evaluated. The position and/or speed of the piston 7 can then be determined from the transit time with high accuracy and robustness.

In some implementations, the piston-cylinder unit 1 with the integrated piston movement sensor 28 can be designed in accordance with protection class IP69K.

It is possible that the piston movement sensor 28 can be used to determine a stroke that is in the range of 10 mm to 2,000 mm, for example 30 mm to 1,800 mm or 40 mm to 1,600 mm. Here, for example, a resolution in the range of 0.2 mm to 4 mm, for example 0.5 to 2 mm or 0.8 to 1.5 mm, can be achieved.

Another advantage of the sealing of the sensor signal channel 26 by a sealing element or a multifunctional collimator 35 is that high hydraulic pressures, which can be, for example, 100 bar to 600 bar, do not lead to deformations, stresses and damage to the piston movement sensor 28, the sensor housing 55 and/or the electronic components of the piston movement sensor 28.

The pico-clasp connector used for the sensor cable 43 and its connection to the piston movement sensor 28 and the housing plug 44 can have five pins, which can be assigned GND, VDC, CAN LO, CAN HI and an analog signal.

The analog signal can be used to transmit a pulse width modulated signal (PWM), with the measurement signal being transmitted via pulse width modulation. Alternatively, it is possible that a voltage or a current that is proportional to the measurement signal is transmitted as an analog signal. If a PWM signal is transmitted, it can have, in some implementations, a frequency of approximately 500 Hz. The duty cycle provides information about the measured path of the piston. For example, if the piston is fully retracted, the duty cycle can be 5%, while for the fully extended state of the piston, the duty cycle can be 95%.

The piston movement sensor 28 may not only measure the stroke and/or the speed of the piston 7 or the piston rod 8. It is possible that, alternatively (or in addition), other measured variables (such as the temperature) can also be measured, transmitted and/or evaluated. Temperature measurements can be used, for example, for temperature compensation.

It is also possible that a bidirectional transmission is possible via the housing plug 44, which also allows a software update of the piston movement sensor 28 to take place and update functions to be carried out by the piston movement sensor 28.

FIGS. 10A-10B show another embodiment of a piston and cylinder unit 1001. FIG. 10A is a cross-section side view 1000 of a hydraulic cylinder 1001 (e.g., a piston and cylinder unit 1001) including a sensor assembly block 1002, including a sensor unit 1004 and a dielectric lens 1003. The sensor assembly block 1002 that further includes a dielectric lens 1003 and cylinder sensor unit 1004. The hydraulic cylinder 1001 includes a cylinder head 1008 at a first end of the hydraulic cylinder 1001 (e.g., depicted on the right-hand side of the page), and includes a piston rod eye 1022 at a second end of the hydraulic cylinder 1001 (e.g., opposite the first end of the hydraulic cylinder, on the left-hand side of the page). The cylinder head 1008 includes a bearing bushing 1010 arranged in an area of the cylinder head 1008, and the piston rod eye 1022 includes bearing bushing 1024 arranged in an area of the piston rod eye 1022. Each of the bearing bushings 1010, 1024 facilitate connections between the hydraulic cylinder 1001 and a machine, e.g., to provide motion for the machine.

FIG. 10A shows a longitudinal center axis 1028 illustrated as a dashed line across the length of the hydraulic cylinder 1001 as a reference for the insertion of components into portions of the hydraulic cylinder 1001. For example, a cylinder sensor unit 1004 can be inserted into the cylinder head 1008 by a sensor mounting bore 1005 (also referred to as a “cavity 1005”). FIG. 10A also shows a vertical axis 1009 illustrated as a dashed line substantially perpendicular to the longitudinal center axis 1028, as a reference for the insertion of components into portions of the hydraulic cylinder 1001. For example, the sensor assembly block 1002 can be inserted radially into the cavity 1005 of the cylinder head 1008.

The cylinder head 1008 is coupled to a cylinder body 1014, which further includes a cylinder housing 1042 (also referred to as “housing 1042”). The housing 1042 is configured to house the components of the cylinder body 1014, such as a piston 1012, piston rod 1020, etc. The piston 1012 is connected to a piston rod 1020, in which the piston rod eye 1022 is arranged at the second end of the hydraulic cylinder 1001. The housing 1042 can be sealed, e.g., hermetically, using a number of components (e.g., mechanical gaskets, seals, rings) to maintain pressure inside of the hydraulic cylinder 1001.

The piston 1012 effectively separates an interior of the cylinder body 1014 into a pair of pressure chambers 1016 and 1033 on either side of the piston 1012. The interior of the cylinder body 1014 can be filled with a hydraulic fluid via a connection, e.g., by port 1018. For example, pressure chamber 116 is illustrated adjacent and to the left of the piston 112, whereas pressure chamber 133 is illustrated to the right of the piston 112. The pressure chamber 1016 is formed in the interior of the cylinder body 1014 and surrounds the piston rod 1020. Referring to ports 1018 and 1055 of the hydraulic cylinder 1001, the ports can be filled with hydraulic fluid to generate different amounts of pressure to generate motion for the piston. Port 1018 can be configured to fill the pressure chamber 1016, while port 1055 can be configured to fill the pressure chamber 1033.

For example, a hydraulic circuit (not illustrated in FIG. 10A), with a hydraulic pump and changeover valves is connected to the port 1018 and/or port 1055 to allow exchange of hydraulic fluids and generate different amounts of pressure. For example, depending the pressure generated by means of the hydraulic circuit at the port 1018 and/or port 1055, an actuating force can be generated hydraulically with both directions along the longitudinal center axis 1028, which acts on the piston 1012, and with the resulting actuating movement of the piston 1012, a change in the volume of the pressure chambers 1016 and 1033.

Although FIG. 10A shows the piston 1012 and the piston rod 1020 in a fully retracted position within the cylinder body 1014, the piston 1012 and the piston rod 1020 can also be extended by sliding along the longitudinal center axis 1028. As the piston 1012 slides along longitudinal axis 1028, the relative sizes of the pressure chambers 1016 and 1033 on either side of the piston 1012 will correspondingly change based on the position of piston 1012 within the cylinder body 1014. A rod seal 1038 and an O-ring 1036 are provided for storage and sealing at a bottom portion of the cylinder body 1014. The bottom portion of the cylinder body 1014 also includes a slide bearing 1032 to support sliding motions of the piston rod 1020. The cylinder body 1014 includes a guide bushing 1013 on a front portion of the cylinder body 1014 (e.g., left hand side of the page) to stabilize and guide the movement of the piston rod 1020 within the cylinder body 1014, by stabilizing the piston rod as it extends and retracts in the cylinder body 1014.

The piston 1012 is rotationally fixed to the piston rod 1020 and secured by means of a lock nut 1026. Furthermore, an O-ring 1046, a piston guide ring 1048, a piston seal 1050, and a further piston guide ring 1052 are arranged on the piston 1012. In this way, piston 1012, piston rod 1020, and piston rod eye 1022 form a slidable unit along axis 1028 while maintaining a seal between pressure chambers 1016, 1033. To the right of the pressure chamber 1033 (e.g., enclosed by the cylinder housing 1042, a partial chamber 1054 of the pressure chamber 1033 in the cylinder head 1008 connects the cylinder head 1008 to the cylinder body 1014. The partial chamber 1054 includes an axially extending sensor signal channel 1027, shown in FIG. 10A as part of the pressure chamber 1033 and thus exposed to hydraulic fluid. The sensor signal channel 1027 is in turn connected to the cavity 1005, which extends radially relative to the longitudinal center axis 1028 in the cylinder head 1008. The cavity 1005 extends to the outer surface of the cylinder head 1008 and can be connected to the environment by means of an unillustrated compensation hole. The sensor signal channel 1027 is adjacent to the dielectric lens 1003, to facilitate propagation of electromagnetic beams between the cylinder body 1014 and the cylinder sensor unit 1004 of the sensor assembly block 1002.

FIG. 10B is a close-up, cross-sectional view 1060 of the longitudinal section (e.g., a longitudinal portion) of the piston and cylinder unit 1001 shown in FIG. 10A. The sensor block 1002 is arranged in the cavity 1005, such that the cylinder sensor unit 1004 (also referred to as a “piston position detection unit 1004” or “sensor unit 1004”) can be used to detect the axial position of the piston 1012 and/or the piston rod 1020 in the cylinder body 1014 using high-frequency technology (e.g., using radar signals). The sensor block 1002 can include a housing for the sensor unit 1004, e.g., to secure the sensor unit 1004 in the cavity 1005.

The sensor unit 1004 can be a radar sensing unit that includes one or more radar sensors and/or emitters configured to emit radar signals into the cylinder body 1014 and detect reflected radar signals. The sensor unit 1004 sends out a high-frequency signal, which hits the end face of the piston 1012 or the piston rod 1020 through the sensor signal channel 1027 and through the partial chamber 1054 as well as through the pressure chamber 1033 and, after reflection through this end face, returns to the sensor unit 1004.

The movement of the signal, in particular the path traveled by the end face, can then be determined from the reflected signal using high-frequency technology, in particular by evaluating the transit time. For example, an electronic unit connected to or included in the sensor unit 1004 (including electronic components and software executed by these components) can carry out an evaluation of the reflected signals to determines the current position of the piston 1012 along the longitudinal center axis 1028. This determination can be conducted permanently, in defined time intervals, continuously, or at specific points in time. In some implementations, the result or a command being associated with the result is transmitted to an electronic computing unit of the working machine connected therewith—a part of which is the hydraulic cylinder 1001.

The sensor unit 1004 can be used to directly measure the stroke of the piston 1012 or the piston rod 1020 within the cylinder body 1014. The sensor unit 1004 is preferably based on a non-contact measuring radar system in which the transit time between a transmitting unit and the end face of the piston 1012 or the piston rod 1020 and the reflected signal received at a receiving unit is evaluated. The position and/or speed of the piston 1012 can then be determined from the transit time with high accuracy and robustness. For example, the sensor unit 1004 can be used to determine a stroke that is in the range of 10 mm to 2,000 mm, for example 30 mm to 1,800 mm or 40 mm to 1,600 mm. Here, for example, a radar detection resolution in the range of 0.2 mm to 4 mm, for example 0.5 to 2 mm or 0.8 to 1.5 mm, can be achieved.

The sensor block 1002 can include a sensor housing 1006 that that includes the sensor unit 1004 coupled to the dielectric lens 1003. The sensor block 1004 can be position in the cavity 1005 to form a seal that prevents the hydraulic fluid from escaping, e.g., from the partial chamber 1054 and into the sensor unit 1004. The seal can be formed between the partial chamber 1054 and the dielectric lens 1003, and between the dielectric lens 1003 and the sensor housing 1006.

The dielectric lens 1003 is configured to direct high-frequency signals in a way that improves measurement accuracy of the sensor unit 1004. The dielectric lens 1003 can be formed such that beams that were previously non-parallel beams (e.g., from divergent sources) can be made parallel to one another, e.g., converting parallel beams to non-parallel beams and vice-versa. For example, the sensor unit 1004 can transmit beams from a central point (e.g., a transmitter or transceiver of the sensor unit) to a front side of the piston 1012 and/or the piston rod 1020. The dielectric lens 1003 converts the non-parallel beams into a set of parallel beams while the beams propagate through the dielectric lens 1003, such that the beams exit through the dielectric lens substantially parallel, e.g., relative to one another. Upon the beams illuminating parts of the cylinder body 1014, the resulting return signals (e.g., including information for forming detections by the sensor unit) are reflected back into parallel beams. The dielectric lens 1003 can be configured to receive the return signals at substantially parallel beams and bundle the beams back to a central point of the sensor unit 1004, e.g., a receiver or transceiver of the sensor unit.

In some implementations, the dielectric lens 1003 can be configured (e.g., based on the material and/or shape) to serve as a filter that focuses only on high-frequency beams or substantially high-frequency beams for the sensor unit, e.g., beams that have propagated through the dielectric lens at a substantially parallel angle and to the longitudinal center axis 1028. This allows high-frequency radiation to be filtered out that does not originate, or at least does not originate directly from an end of the piston 1012 and/or piston rod 1020. A source of clutter from the receive signals can result from the fact the refraction/reflection of beams may not be ideal, e.g., beams transmitted and/or received may not occur punctually or surfaces may not be ideally flat.

The dielectric lens 1003 can be made up or have a dielectric plastic or a dielectric ceramic, polytetrafluoroethylene, polyethylene or polypropylene. The dielectric lens 1003 preferably has a dielectric constant (permittivity) greater than that of air and greater than that of the hydraulic fluid in the piston-cylinder unit. For example, the permittivity can be between 20% and 50% greater than that of the hydraulic fluid in the cylinder body 1014. The permittivity difference and the curvature of the dielectric lens are coordinated. In some implementations, the dielectric lens 1003 may be formed by the sensor block 1002 or by the sensor unit 1004 itself, although the sensor housings can be structurally separated.

FIG. 10B also illustrates a housing connector 1070 for carrying electrical signals, such as a pico-clasp plug that can be used to connect a housing plug 1062 to the sensor unit 1004, e.g., by mounting the sensor unit 1004 onto a substrate 1074 and coupling the housing connector 1070 to the substrate 1074. For example, the substrate 1074 can include one or more ports configured to receive the housing connector 1070. The substrate 1074 can include one or more electrical components mounted on a surface of the substrate 1074, embedded in the substrate 1074, etc. In some implementations, the substrate 1074 is a printed circuit board (PCB), with a number of electrical components mounted on the PCB. Examples of additional components can include various power stage components such as amplifiers, current/voltage regulators and converters, etc.

The sensor block 1002 can include the housing plug 1062 with a number of components that facilitate connections to and from a device for providing control to the hydraulic cylinder, e.g., a computing device. For example, the housing plug 1062 includes a connector plug 1064 to couple to a connector cable from a device to provide signals to the sensor unit 1004. The sensor block 1002 can include a housing connector 1070 that attaches to the sensor unit 1004 (e.g., through the housing connector 170 coupled to the PCB 174, where the sensor unit 104 is mounted) using a number of wires 1066. In some cases, the housing connector 1070 can be coupled to the sensor unit 1004, prior to the insertion of the sensor unit 1004 into the cavity 1005. In some implementations, the housing connector 1070 and/or the connector plug 1064 is an M12 connector, although any other type of hydraulic cylinder connector configured to carry to provide signals may be utilized. The sensor block 1002 can include one or more fixing screws to affix the housing plug 1062 to the cylinder head 1008. The cylinder 1001 also includes a threaded pipe 1072, which can be used to align the position of the cavity to the sensor block 1002.

The housing plug 1062 includes a number of pins, e.g., ground, DC voltage, analog signal, high-speed bus, low-speed bus for communication to and from the sensor unit 1004 and other devices. For example, the housing plug 1062 can use an analog signal to provide pulse-width modulated pulses or voltage signals. The sensor block 1002 can include one or more fixing screws 1068 to affix the housing plug 1062 to the cylinder head 1008. The sensor block 1002 also includes a threaded pipe 1072 which can be used to align the position of the sensor housing 1004 in the cavity 1005.

Many variations and modifications may be made to the example embodiments of the piston and cylinder units 1, 1001 described in relation to FIGS. 2-9 and FIGS. 10A-10B without departing substantially from the spirit and principles of the technology disclosed in this specification. In general, the techniques described herein can be implemented using any piston and cylinder unit that includes a radar sensing unit (e.g., the piston position detection unit 28) that transmits radar signals through a hydraulic fluid (e.g., oil) to detect a position of the piston (e.g., the piston 7) within the cylinder (e.g., the cylinder 2). All such modifications and variations are intended to be included herein within the scope of the present disclosure.

FIG. 19 shows an example of a computing device 1900 and a mobile computing device 1950 that are employed to execute implementations of the present disclosure. For example, the computing device 1900 and/or the mobile computing device 1950 can correspond to computing devices such as microcontrollers (or other computing devices) connected to or included within the radar sensing unit 108, the piston position detection unit 28, and/or the piston and cylinder units 1 and 100. The computing device 1900 and/or the mobile computing device 1950 can be employed to execute one or more steps of the process 100 including operations 104, 106, 108, 110, 112, and 114 and sub-operations 1102, 1104, 1106, 1108, 1302, 1304, 1306, 1502, and 1504. Instances of the computing device 1900 and/or the mobile computing device 1950 can also be employed to generate and/or display the plots 1200, 1400, and 1600A-1600C. In some implementations, instances of the computing device 1900 and/or the 1950 can also be employed to perform supporting steps to the process 100 such as controlling the movement of the piston to the defined position within the hydraulic cylinder, controlling the radar sensing unit to emit a radar signal, and/or controlling the radar sensing unit to collect the reflected signal corresponding to the emitted radar signal. In some implementations, the computing device 1900 and/or the 1950 can implement computer software such as computer software that is executable to perform one or more steps of the process 100 and/or to perform one of the other functions described herein.

In some implementations, the computing devices connected to or included within the radar sensing unit 108, the piston position detection unit 28, and/or the piston and cylinder units 1 and 100 can include a singular computing device 1900 or mobile computing device 1950. However, in other implementations, the computing devices connected to or included within the radar sensing unit 108, the piston position detection unit 28, and/or the piston and cylinder units 1 and 100 can include multiple computing devices 1900 and/or mobile computing devices 1950 that jointly perform the operations disclosed above in a distributed manner (e.g., via cloud computing). Moreover, in some implementations, computing tasks performed by the computing devices connected to or included within the radar sensing unit 108, the piston position detection unit 28, and/or the piston and cylinder units 1 and 100 can be redistributed amongst one another without limitation, unless otherwise stated herein.

The computing device 1900 is intended to represent various forms of digital computers, such as laptops, desktops, workstations, personal digital assistants, servers, blade servers, mainframes, and other appropriate computers. The mobile computing device 1950 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting.

The computing device 1900 includes a processor 1902, a memory 1904, a storage device 1906, a high-speed interface 1908, and a low-speed interface 1912. In some implementations, the high-speed interface 1908 connects to the memory 1904 and multiple high-speed expansion ports 1910. In some implementations, the low-speed interface 1912 connects to a low-speed expansion port 1914 and the storage device 1906. Each of the processor 1902, the memory 1904, the storage device 1906, the high-speed interface 1908, the high-speed expansion ports 1910, and the low-speed interface 1912, are interconnected using various buses, and may be mounted on a common motherboard or in other manners as appropriate. The processor 1902 can process instructions for execution within the computing device 1900, including instructions stored in the memory 1904 and/or on the storage device 1906 to display graphical information for a graphical user interface (GUI) on an external input/output device, such as a display 1916 coupled to the high-speed interface 1908. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 1904 stores information within the computing device 1900. In some implementations, the memory 1904 is a volatile memory unit or units. In some implementations, the memory 1904 is a non-volatile memory unit or units. The memory 1904 may also be another form of a computer-readable medium, such as a magnetic or optical disk.

The storage device 1906 is capable of providing mass storage for the computing device 1900. In some implementations, the storage device 1906 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 1902, perform one or more methods, such as those described above. The instructions can also be stored by one or more storage devices, such as computer-readable or machine-readable mediums, such as the memory 1904, the storage device 1906, or memory on the processor 1902.

The high-speed interface 1908 manages bandwidth-intensive operations for the computing device 1900, while the low-speed interface 1912 manages lower bandwidth-intensive operations. Such allocation of functions is an example only. In some implementations, the high-speed interface 1908 is coupled to the memory 1904, the display 1919 (e.g., through a graphics processor or accelerator), and to the high-speed expansion ports 1910, which may accept various expansion cards. In the implementation, the low-speed interface 1912 is coupled to the storage device 1906 and the low-speed expansion port 1914. The low-speed expansion port 1914, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 1914 through a network adapter. Such network input/output devices may include, for example, a switch or router.

The computing device 1900 may be implemented in a number of different forms, as shown in FIG. 19. For example, it may be implemented as a standard server 1920, or multiple times in a group of such servers. In addition, it may be implemented in a personal computer such as a laptop computer 1922. It may also be implemented as part of a rack server system 1924. Alternatively, components from the computing device 1900 may be combined with other components in a mobile device, such as a mobile computing device 1950. Each of such devices may contain one or more of the computing device 1900 and the mobile computing device 1950, and an entire system may be made up of multiple computing devices communicating with each other.

The mobile computing device 1950 includes a processor 1952; a memory 1964; an input/output device, such as a display 1954; a communication interface 1966; and a transceiver 1968; among other components. The mobile computing device 1950 may also be provided with a storage device, such as a micro-drive or other device, to provide additional storage. Each of the processor 1952, the memory 1964, the display 1954, the communication interface 1966, and the transceiver 1968, are interconnected using various buses, and several of the components may be mounted on a common motherboard or in other manners as appropriate. In some implementations, the mobile computing device 1950 may include a camera device(s).

The processor 1952 can execute instructions within the mobile computing device 1950, including instructions stored in the memory 1964. The processor 1952 may be implemented as a chipset of chips that include separate and multiple analog and digital processors. For example, the processor 1952 may be a Complex Instruction Set Computers (CISC) processor, a Reduced Instruction Set Computer (RISC) processor, or a Minimal Instruction Set Computer (MISC) processor. The processor 1952 may provide, for example, for coordination of the other components of the mobile computing device 1950, such as control of user interfaces (UIs), applications run by the mobile computing device 1950, and/or wireless communication by the mobile computing device 1950.

The processor 1952 may communicate with a user through a control interface 1958 and a display interface 1956 coupled to the display 1954. The display 1954 may be, for example, a Thin-Film-Transistor Liquid Crystal Display (TFT) display, an Organic Light Emitting Diode (OLED) display, or other appropriate display technology. The display interface 1956 may include appropriate circuitry for driving the display 1954 to present graphical and other information to a user. The control interface 1958 may receive commands from a user and convert them for submission to the processor 1952. In addition, an external interface 1962 may provide communication with the processor 1952, so as to enable near area communication of the mobile computing device 1950 with other devices. The external interface 1962 may provide, for example, for wired communication in some implementations, or for wireless communication in other implementations, and multiple interfaces may also be used.

The memory 1964 stores information within the mobile computing device 1950. The memory 1964 can be implemented as one or more of a computer-readable medium or media, a volatile memory unit or units, or a non-volatile memory unit or units. An expansion memory 1974 may also be provided and connected to the mobile computing device 1950 through an expansion interface 1972, which may include, for example, a Single in Line Memory Module (SIMM) card interface. The expansion memory 1974 may provide extra storage space for the mobile computing device 1950, or may also store applications or other information for the mobile computing device 1950. Specifically, the expansion memory 1974 may include instructions to carry out or supplement the processes described above, and may include secure information also. Thus, for example, the expansion memory 1974 may be provided as a security module for the mobile computing device 1950, and may be programmed with instructions that permit secure use of the mobile computing device 1950. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 1952, perform one or more methods, such as those described above. The instructions can also be stored by one or more storage devices, such as one or more computer-readable or machine-readable mediums, such as the memory 1964, the expansion memory 1974, or memory on the processor 1952. In some implementations, the instructions can be received in a propagated signal, such as, over the transceiver 1968 or the external interface 1962.

The mobile computing device 1950 may communicate wirelessly through the communication interface 1966, which may include digital signal processing circuitry where necessary. The communication interface 1966 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 1968 using a radio frequency. In addition, short-range communication, such as using a Bluetooth or Wi-Fi, may occur. In addition, a Global Positioning System (GPS) receiver module 1970 may provide additional navigation- and location-related wireless data to the mobile computing device 1950, which may be used as appropriate by applications running on the mobile computing device 1950.

The mobile computing device 1950 may also communicate audibly using an audio codec 1960, which may receive spoken information from a user and convert it to usable digital information. The audio codec 1960 may likewise generate audible sound for a user, such as through a speaker, e.g., in a handset of the mobile computing device 1950. Such sound may include sound from voice telephone calls, may include recorded sound (e.g., voice messages, music files, etc.) and may also include sound generated by applications operating on the mobile computing device 1950.

The mobile computing device 1950 may be implemented in a number of different forms, as shown in FIG. 19. For example, it may be implemented a phone device 1980, a personal digital assistant 1982, and a tablet device (not shown). The mobile computing device 1950 may also be implemented as a component of a smart-phone, AR device, or other similar mobile device.

Computing device 1900 and/or 1950 can also include USB flash drives. The USB flash drives may store operating systems and other applications. The USB flash drives can include input/output components, such as a wireless transmitter or USB connector that may be inserted into a USB port of another computing device.

While this specification contains many specific implementation details, these should not be construed as limitations on the scope of the technology described in this specification or on the scope of what may be claimed, but rather as descriptions of features that may be specific to particular embodiments of the disclosed technology. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Other embodiments and applications not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

Some of the examples described herein include or are defined by the following implementations.

Implementation A1 is a method for calibrating a radar sensor used in a hydraulic cylinder, the method comprising: calculating a position-dependent noise estimate; setting a position-dependent threshold amplitude for piston position detection based on the calculated position-dependent noise estimate, wherein a piston is determined to be detected at a particular position if a reflected signal received at the radar sensor exceeds the position-dependent threshold amplitude at the particular position; and calibrating radar measurements acquired by the radar sensor to correct for a multi-path position error.

Implementation A2 is the method of A1 further comprising: collecting, using the radar sensor, error measurements at multiple temperatures within the hydraulic cylinder, wherein the error measurements represent a difference between (i) the calibrated radar measurements and (ii) reference positions of the piston that correspond to the calibrated radar measurements; and calibrating the radar measurements acquired by the radar sensor to adjust for temperature fluctuations within the hydraulic cylinder.

Implementation A3 is the method of any of implementations A1-A2, wherein the reference positions of the piston that correspond to the calibrated radar measurements are provided by a reference position sensor.

Implementation A4 is the method of any of implementations A1-A3, wherein calculating the position-dependent noise estimate comprises: setting a threshold amplitude for piston position detection; collecting radar measurements at multiple positions between the radar sensor and the piston; and estimating noise statistics at the multiple positions between the radar sensor and the piston using the radar measurements.

Implementation A5 is the method of any of implementations A1-A4, wherein setting the position-dependent threshold amplitude for piston position detection comprises automatically setting the position-dependent threshold amplitude for piston position detection based on the calculated position-dependent noise estimate.

Implementation A6 is the method of any of implementations A1-A5, wherein automatically setting the position-dependent threshold amplitude for piston position detection based on the calculated position-dependent noise estimate comprises automatically setting the position-dependent threshold amplitude for piston position detection at a defined number of standard deviations above a mean value of the calculated position-dependent noise estimate.

Implementation A7 is the method of any of implementations A1-A6, wherein calibrating the radar measurements acquired by the radar sensor to correct for the multi-path position error comprises: collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions.

Implementation A8 is the method of any of implementations A1-A7, wherein determining the function that estimates the multi-path position error at various piston positions comprises fitting a B-spline curve to error measurements that represent differences between (i) the uncalibrated piston position measurements collected using the radar sensor and (ii) the reference positions of the piston that correspond to the uncalibrated piston position measurements.

Implementation A9 is the method of any of implementations A1-A8, wherein calibrating the radar measurements acquired by the radar sensor to adjust for temperature fluctuations within the hydraulic cylinder comprises: determining a function for estimating a temperature correction that reduces an error between (i) the calibrated radar measurements and (ii) the reference positions of the piston that correspond to the calibrated radar measurements; and adjusting the calibrated radar measurements by the temperature correction estimated by the determined function.

Implementation A10 is the method of any of implementations A1-A9, wherein determining the function for estimating the temperature correction that minimizes the error between (i) the calibrated radar measurements and (ii) the reference positions of the piston that correspond to the calibrated radar measurements comprises: determining one or more coefficients corresponding to an approximation of the error between (i) the calibrated radar measurements and (ii) the reference positions of the piston that correspond to the calibrated radar measurements.

Implementation A11 is the method of any of implementations A1-A10, determining that the piston is likely to be present in a particular section of a plurality of sections that span a length of a cylinder body of the hydraulic cylinder, wherein each section corresponds to a respective portion of the length of the cylinder body; and adjusting one or more measurement parameters to values corresponding to the particular section from the plurality of sections.

Implementation A12 is the method of any of implementations A1-A11, wherein the one or more measurement parameters comprises at least one of a receiver gain associated with the radar sensor or a number of measurements averaged by the radar sensor.

Implementation A13 is the method of any of implementations A1-A12, further comprising: determining that the piston is likely to be present in a particular section of a plurality of sections that span a length of a cylinder body of the hydraulic cylinder, wherein each section corresponds to a respective portion of the length of the cylinder body; and operating the radar sensor to acquire measurement data associated with the particular section.

Implementation A14 is the method of any of implementations A1-A13, further comprising: determining (i) an initial estimated position of the piston in the hydraulic cylinder and (ii) a temperature measurement representative of a temperature associated with the hydraulic cylinder.

Implementation A15 is the method of any of implementations A1-A14, wherein the temperature measurement is a measurement of a temperature of a fluid within the hydraulic cylinder.

Implementation A16 is the method of any of implementations A1-A15, further comprising: determining a plurality of calibration temperatures based on a temperature parameter associated with the hydraulic cylinder; determining a plurality of calibration positions based on an initial estimated position of the piston in the hydraulic cylinder, wherein a plurality of defined sections comprise the plurality of calibration positions, wherein the plurality of defined sections span a length of a cylinder body of the hydraulic cylinder, and wherein each section from the plurality of defined sections corresponds to a respective portion of the length of the cylinder body; and generating a plurality of functions based on the plurality of calibration positions and the plurality of calibration temperatures, wherein each function from the plurality of functions estimates the multi-path position error at various piston positions of the hydraulic cylinder, wherein each function from the plurality of functions is generated from a respective combination of at least one temperature from the plurality of calibration temperatures and at least one calibration position from the plurality of calibration positions.

Implementation A17 is the method of any of implementations A1-A16, wherein determining the function that estimates the multi-path position error at various piston positions comprises: selecting one or more functions from the plurality of functions based on a first estimated position of the piston in the hydraulic cylinder and a first temperature parameter of the hydraulic cylinder.

Implementation A18 is the method of any of implementations A1-A17, further comprising: predicting, using the one or more selected functions, the multi-path position error, wherein the predicting comprises reducing, using the one or more selected functions, an error between (i) the calibrated radar measurements and (ii) reference positions of the piston that correspond to the calibrated radar measurements; and adjusting the calibrated radar measurements by the multi-path position error predicted by the one or more selected functions.

Implementation B1 is a system comprising: at least one processor; and one or more storage devices communicatively coupled to the at least one processor, the one or more storage devices storing instructions which, when executed by the at least one processor, cause the at least one processor to perform operations comprising: calculating a position-dependent noise estimate; setting a position-dependent threshold amplitude for piston position detection based on the calculated position-dependent noise estimate, wherein a piston is determined to be detected at a particular position if a reflected signal received at a radar sensor exceeds the position-dependent threshold amplitude at the particular position; and calibrating radar measurements acquired by the radar sensor to correct for a multi-path position error.

Implementation B2 is the system of B1, the operations further comprising: collecting, using the radar sensor, error measurements at multiple temperatures within the hydraulic cylinder, wherein the error measurements represent a difference between (i) the calibrated radar measurements and (ii) reference positions of the piston that correspond to the calibrated radar measurements; and calibrating the radar measurements acquired by the radar sensor to adjust for temperature fluctuations within the hydraulic cylinder.

Implementation B3 is the system of any of implementations B1-B2, wherein the reference positions of the piston that correspond to the calibrated radar measurements are provided by a reference position sensor.

Implementation B4 is the system of any of implementations B1-B3, wherein calculating the position-dependent noise estimate comprises: setting a threshold amplitude for piston position detection; collecting radar measurements at multiple positions between the radar sensor and the piston; and estimating noise statistics at the multiple positions between the radar sensor and the piston using the radar measurements.

Implementation B5 is the system of any of implementations B1-B4, wherein setting the position-dependent threshold amplitude for piston position detection comprises automatically setting the position-dependent threshold amplitude for piston position detection based on the calculated position-dependent noise estimate.

Implementation B6 is the system of any of implementations B1-B5, wherein automatically setting the position-dependent threshold amplitude for piston position detection based on the calculated position-dependent noise estimate comprises automatically setting the position-dependent threshold amplitude for piston position detection at a defined number of standard deviations above a mean value of the calculated position-dependent noise estimate.

Implementation B7 is the system of any of implementations B1-B6, wherein calibrating the radar measurements acquired by the radar sensor to correct for the multi-path position error comprises: collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions.

Implementation B8 is the system of any of implementations B1-B7, wherein determining the function that estimates the multi-path position error at various piston positions comprises fitting a B-spline curve to error measurements that represent differences between (i) the uncalibrated piston position measurements collected using the radar sensor and (ii) the reference positions of the piston that correspond to the uncalibrated piston position measurements.

Implementation B9 is the system of any of implementations B1-B8, wherein calibrating the radar measurements acquired by the radar sensor to adjust for temperature fluctuations within the hydraulic cylinder comprises: determining a function for estimating a temperature correction that reduces an error between (i) the calibrated radar measurements and (ii) the reference positions of the piston that correspond to the calibrated radar measurements; and adjusting the calibrated radar measurements by the temperature correction estimated by the determined function.

Implementation B10 is the system of any of implementations B1-B9, wherein determining the function for estimating the temperature correction that minimizes the error between (i) the calibrated radar measurements and (ii) the reference positions of the piston that correspond to the calibrated radar measurements comprises: determining one or more coefficients corresponding to an approximation of the error between (i) the calibrated radar measurements and (ii) the reference positions of the piston that correspond to the calibrated radar measurements.

Implementation B11 is the system of any of implementations B1-B10, determining that the piston is likely to be present in a particular section of a plurality of sections that span a length of a cylinder body of the hydraulic cylinder, wherein each section corresponds to a respective portion of the length of the cylinder body; and adjusting one or more measurement parameters to values corresponding to the particular section from the plurality of sections.

Implementation B12 is the system of any of implementations B1-B11, wherein the one or more measurement parameters comprises at least one of a receiver gain associated with the radar sensor or a number of measurements averaged by the radar sensor.

Implementation B13 is the system of any of implementations B1-B12, the operations further comprising: determining that the piston is likely to be present in a particular section of a plurality of sections that span a length of a cylinder body of the hydraulic cylinder, wherein each section corresponds to a respective portion of the length of the cylinder body; and operating the radar sensor to acquire measurement data associated with the particular section.

Implementation B14 is the system of any of implementations B1-B13, the operations further comprising: determining (i) an initial estimated position of the piston in the hydraulic cylinder and (ii) a temperature measurement representative of a temperature associated with the hydraulic cylinder.

Implementation B15 is the system of any of implementations B1-B14, wherein the temperature measurement is a measurement of a temperature of a fluid within the hydraulic cylinder.

Implementation B16 is the system of any of implementations B1-B15, the operations further comprising: determining a plurality of calibration temperatures based on a temperature parameter associated with the hydraulic cylinder; determining a plurality of calibration positions based on an initial estimated position of the piston in the hydraulic cylinder, wherein a plurality of defined sections comprise the plurality of calibration positions, wherein the plurality of defined sections span a length of a cylinder body of the hydraulic cylinder, and wherein each section from the plurality of defined sections corresponds to a respective portion of the length of the cylinder body; and generating a plurality of functions based on the plurality of calibration positions and the plurality of calibration temperatures, wherein each function from the plurality of functions estimates the multi-path position error at various piston positions of the hydraulic cylinder, wherein each function from the plurality of functions is generated from a respective combination of at least one temperature from the plurality of calibration temperatures and at least one calibration position from the plurality of calibration positions.

Implementation B17 is the system of any of implementations B1-B16, wherein determining the function that estimates the multi-path position error at various piston positions comprises: selecting one or more functions from the plurality of functions based on a first estimated position of the piston in the hydraulic cylinder and a first temperature parameter of the hydraulic cylinder.

Implementation B18 is the system of any of implementations B1-B17, the operations further comprising: predicting, using the one or more selected functions, the multi-path position error, wherein the predicting comprises reducing, using the one or more selected functions, an error between (i) the calibrated radar measurements and (ii) reference positions of the piston that correspond to the calibrated radar measurements; and adjusting the calibrated radar measurements by the multi-path position error predicted by the one or more selected functions.

Implementation C1 is one or more non-transitory machine-readable storage devices having encoded thereon computer readable instructions for causing one or more processing devices to perform operations for calibrating a radar sensor used in a hydraulic cylinder, wherein the operations comprise: calculating a position-dependent noise estimate; setting a position-dependent threshold amplitude for piston position detection based on the calculated position-dependent noise estimate, wherein a piston is determined to be detected at a particular position if a reflected signal received at the radar sensor exceeds the position-dependent threshold amplitude at the particular position; and calibrating radar measurements acquired by the radar sensor to correct for a multi-path position error.

Implementation C2 is the one or more non-transitory machine-readable storage devices of C1, the operations further comprising: collecting, using the radar sensor, error measurements at multiple temperatures within the hydraulic cylinder, wherein the error measurements represent a difference between (i) the calibrated radar measurements and (ii) reference positions of the piston that correspond to the calibrated radar measurements; and calibrating the radar measurements acquired by the radar sensor to adjust for temperature fluctuations within the hydraulic cylinder.

Implementation C3 is the one or more non-transitory machine-readable storage devices of any of implementations C1-C2, wherein the reference positions of the piston that correspond to the calibrated radar measurements are provided by a reference position sensor.

Implementation C4 is the one or more non-transitory machine-readable storage devices of any of implementations C1-C3, wherein calculating the position-dependent noise estimate comprises: setting a threshold amplitude for piston position detection; collecting radar measurements at multiple positions between the radar sensor and the piston; and estimating noise statistics at the multiple positions between the radar sensor and the piston using the radar measurements.

Implementation C5 is the one or more non-transitory machine-readable storage devices of any of implementations C1-C4, wherein setting the position-dependent threshold amplitude for piston position detection comprises automatically setting the position-dependent threshold amplitude for piston position detection based on the calculated position-dependent noise estimate.

Implementation C6 is the one or more non-transitory machine-readable storage devices of any of implementations C1-C5, wherein automatically setting the position-dependent threshold amplitude for piston position detection based on the calculated position-dependent noise estimate comprises automatically setting the position-dependent threshold amplitude for piston position detection at a defined number of standard deviations above a mean value of the calculated position-dependent noise estimate.

Implementation C7 is the one or more non-transitory machine-readable storage devices of any of implementations C1-C6, wherein calibrating the radar measurements acquired by the radar sensor to correct for the multi-path position error comprises: collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions.

Implementation C8 is the one or more non-transitory machine-readable storage devices of any of implementations C1-C7, wherein determining the function that estimates the multi-path position error at various piston positions comprises fitting a C-spline curve to error measurements that represent differences between (i) the uncalibrated piston position measurements collected using the radar sensor and (ii) the reference positions of the piston that correspond to the uncalibrated piston position measurements.

Implementation C9 is the one or more non-transitory machine-readable storage devices of any of implementations C1-C8, wherein calibrating the radar measurements acquired by the radar sensor to adjust for temperature fluctuations within the hydraulic cylinder comprises: determining a function for estimating a temperature correction that reduces an error between (i) the calibrated radar measurements and (ii) the reference positions of the piston that correspond to the calibrated radar measurements; and adjusting the calibrated radar measurements by the temperature correction estimated by the determined function.

Implementation C10 is the one or more non-transitory machine-readable storage devices of any of implementations C1-C9, wherein determining the function for estimating the temperature correction that minimizes the error between (i) the calibrated radar measurements and (ii) the reference positions of the piston that correspond to the calibrated radar measurements comprises: determining one or more coefficients corresponding to an approximation of the error between (i) the calibrated radar measurements and (ii) the reference positions of the piston that correspond to the calibrated radar measurements.

Implementation C11 is the one or more non-transitory machine-readable storage devices of any of implementations C1-C10, determining that the piston is likely to be present in a particular section of a plurality of sections that span a length of a cylinder body of the hydraulic cylinder, wherein each section corresponds to a respective portion of the length of the cylinder body; and adjusting one or more measurement parameters to values corresponding to the particular section from the plurality of sections.

Implementation C12 is the one or more non-transitory machine-readable storage devices of any of implementations C1-C11, wherein the one or more measurement parameters comprises at least one of a receiver gain associated with the radar sensor or a number of measurements averaged by the radar sensor.

Implementation C13 is the one or more non-transitory machine-readable storage devices of any of implementations C1-C12, the operations further comprising: determining that the piston is likely to be present in a particular section of a plurality of sections that span a length of a cylinder body of the hydraulic cylinder, wherein each section corresponds to a respective portion of the length of the cylinder body; and operating the radar sensor to acquire measurement data associated with the particular section.

Implementation C14 is the one or more non-transitory machine-readable storage devices of any of implementations C1-C13, the operations further comprising: determining (i) an initial estimated position of the piston in the hydraulic cylinder and (ii) a temperature measurement representative of a temperature associated with the hydraulic cylinder.

Implementation C15 is the one or more non-transitory machine-readable storage devices of any of implementations C1-C14, wherein the temperature measurement is a measurement of a temperature of a fluid within the hydraulic cylinder.

Implementation C16 is the one or more non-transitory machine-readable storage devices of any of implementations C1-C15, the operations further comprising: determining a plurality of calibration temperatures based on a temperature parameter associated with the hydraulic cylinder; determining a plurality of calibration positions based on an initial estimated position of the piston in the hydraulic cylinder, wherein a plurality of defined sections comprise the plurality of calibration positions, wherein the plurality of defined sections span a length of a cylinder body of the hydraulic cylinder, and wherein each section from the plurality of defined sections corresponds to a respective portion of the length of the cylinder body; and generating a plurality of functions based on the plurality of calibration positions and the plurality of calibration temperatures, wherein each function from the plurality of functions estimates the multi-path position error at various piston positions of the hydraulic cylinder, wherein each function from the plurality of functions is generated from a respective combination of at least one temperature from the plurality of calibration temperatures and at least one calibration position from the plurality of calibration positions.

Implementation C17 is the one or more non-transitory machine-readable storage devices of any of implementations C1-C16, wherein determining the function that estimates the multi-path position error at various piston positions comprises: selecting one or more functions from the plurality of functions based on a first estimated position of the piston in the hydraulic cylinder and a first temperature parameter of the hydraulic cylinder.

Implementation C18 is the one or more non-transitory machine-readable storage devices of any of implementations C1-C17, the operations further comprising: predicting, using the one or more selected functions, the multi-path position error, wherein the predicting comprises reducing, using the one or more selected functions, an error between (i) the calibrated radar measurements and (ii) reference positions of the piston that correspond to the calibrated radar measurements; and adjusting the calibrated radar measurements by the multi-path position error predicted by the one or more selected functions.

Implementation D1 is a method for calibrating a radar sensor used in a hydraulic cylinder, the method comprising: determining a position-dependent noise estimate; configuring a position-dependent threshold amplitude for piston position detection based on the calculated position-dependent noise estimate, wherein a piston is determined to be detected at a particular position in response to receiving a reflected signal at the radar sensor, the reflected radar signal exceeds the position-dependent threshold amplitude at the particular position; calibrating radar measurements acquired by the radar sensor to correct for a multi-path position error.

Implementation D2 is the method of D1, wherein the reference positions of the piston that correspond to the calibrated radar measurements are measurements of the reference positions collected by a reference position sensor.

Implementation D3 is the method of any of implementations D1-D2, wherein determining the function that estimates the multi-path position error at various piston positions comprises determining a B-spline curve corresponding to error measurements representing differences between (i) the uncalibrated piston position measurements collected using the radar sensor and (ii) the reference positions of the piston that correspond to the uncalibrated piston position measurements.

Implementation D4 is the method of any of implementations D1-D3, wherein determining the function for estimating the temperature correction that reduces the error between (i) the calibrated radar measurements and (ii) the reference positions of the piston that correspond to the calibrated radar measurements comprises determining one or more coefficients corresponding to an approximation of the error between (i) the calibrated radar measurements and (ii) the reference positions of the piston that correspond to the calibrated radar measurements.

Implementation D5 is the method of any of implementations D1-D4, the method comprises determining that the piston is likely to be present in a particular section of a plurality of sections that span a length of a cylinder body of the hydraulic cylinder. Each section corresponds to a respective portion of the length of the cylinder body. The method comprises adjusting one or more measurement parameters to values corresponding to the particular section from the plurality of sections.

Implementation E1 is a method for calibrating a radar sensor used in a hydraulic cylinder, the method comprising collecting, using the radar sensor, error measurements at multiple temperatures within the hydraulic cylinder, wherein the error measurements represent a difference between (i) radar measurements acquired by the radar sensor and (ii) reference positions of a piston that correspond to the radar measurements; calibrating the radar measurements acquired by the radar sensor to adjust for temperature fluctuations within the hydraulic cylinder.

Implementation E2 is the method of E1, the method comprises calculating a position-dependent noise estimate; and setting a position-dependent threshold amplitude for piston position detection based on the calculated position-dependent noise estimate, wherein the piston is determined to be detected at a particular position if a reflected signal received at the radar sensor exceeds the position-dependent threshold amplitude at the particular position.

Implementation E3 is the method of any of implementations E1-E2, the method comprises calibrating radar measurements acquired by the radar sensor to correct for a multi-path position error.

Implementation E4 is the method of any of implementations E1-E3, wherein the reference positions of the piston that correspond to the radar measurements can be provided by a reference position sensor.

Implementation E5 is the method of any of implementations E1-E4, wherein the reference position sensor comprises a glass scale encoder coupled to the hydraulic cylinder.

Implementation E6 is the method of any of implementations E1-E5, wherein calculating the position-dependent noise estimate comprises setting a fixed threshold amplitude for piston position detection; collecting radar measurements at multiple positions between the radar sensor and the piston; and estimating noise statistics at the multiple positions between the radar sensor and the piston using the radar measurements.

Implementation E7 is the method of any of implementations E1-E6, wherein setting the position-dependent threshold amplitude for piston position detection comprises automatically setting the position-dependent threshold amplitude for piston position detection based on the calculated position-dependent noise estimate.

Implementation E8 is the method of any of implementations E1-E7, wherein automatically setting the position-dependent threshold amplitude for piston position detection based on the calculated position-dependent noise estimate comprises automatically setting the position-dependent threshold amplitude for piston position detection at a defined number of standard deviations above a mean value of the calculated position-dependent noise estimate.

Implementation E9 is the method of any of implementations E1-E8, wherein calibrating the radar measurements acquired by the radar sensor to correct for the multi-path position error comprises collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions.

Implementation E10 is the method of any of implementations E1-E9, wherein determining the function that estimates the multi-path position error at various piston positions comprises fitting a B-spline curve to error measurements that represent differences between (i) the uncalibrated piston position measurements collected using the radar sensor and (ii) the reference positions of the piston that correspond to the uncalibrated piston position measurements.

Implementation E11 is the method of any of implementations E1-E10, wherein calibrating the radar measurements acquired by the radar sensor to adjust for temperature fluctuations within the hydraulic cylinder comprises determining a function for estimating a temperature correction that minimizes an error between (i) the radar measurements acquired by the radar sensor and (ii) the reference positions of the piston that correspond to the radar measurements; and adjusting the radar measurements by the temperature correction estimated by the determined function.

Implementation E12 is the method of any of implementations E1-El1, wherein determining the function for estimating the temperature correction that minimizes the error between (i) the radar measurements acquired by the radar sensor and (ii) the reference positions of the piston that correspond to the radar measurements comprises determining one or more coefficients corresponding to an approximation of the error between (i) the radar measurements acquired by the radar sensor and (ii) the reference positions of the piston that correspond to the radar measurements.

Implementation E13 is the method of any of implementations E1-E12, the method further comprises defining a plurality of sections of the hydraulic cylinder; identifying that the piston is likely to be present in a particular section of the plurality of sections of the hydraulic cylinder; and varying one or more measurement parameters to pre-defined values corresponding to the particular section.

Implementation E14 is the method of any of implementations E1-E13, the one or more measurement parameters comprises at least one of a receiver gain associated with the radar sensor or a number of measurements averaged by the radar sensor.

Implementation E15 is the method of any of implementations E1-E14, the method further comprises defining a plurality of sections of the hydraulic cylinder; identifying that the piston is likely to be present in a particular section of the plurality of sections of the hydraulic cylinder; and operating the radar sensor to acquire data only for the particular section.

Implementation F1 is a system comprising a hydraulic cylinder that comprises a piston and a radar sensor, the system comprises a noise estimation module configured to calculate a position-dependent noise estimate; a threshold amplitude setting module configured to set a position-dependent threshold amplitude for piston position detection based on the calculated position-dependent noise estimate, wherein the piston is determined to be detected at a particular position if a reflected signal received at the radar sensor exceeds the position-dependent threshold amplitude at the particular position; and a multi-path position error calibration module configured to calibrate radar measurements acquired by the radar sensor to correct for a multi-path position error.

Implementation F2 is the system of implementation F1, the system further comprises a temperature calibration module configured to collect, using the radar sensor, error measurements at multiple temperatures within the hydraulic cylinder, wherein the error measurements represent a difference between (i) the calibrated radar measurements and (ii) reference positions of the piston that correspond to the calibrated radar measurements; and calibrate the radar measurements acquired by the radar sensor to adjust for temperature fluctuations within the hydraulic cylinder.

Implementation F3 is the system of any one of implementations F1-F2, wherein the system comprises a reference position sensor, wherein the reference positions of the piston that correspond to the calibrated radar measurements are provided by the reference position sensor.

Implementation F4 is the system of any one of implementations F1-F3, wherein the reference position sensor comprises a glass scale encoder coupled to the hydraulic cylinder.

Implementation F5 is the system of any one of implementations F1-F4, wherein the position-dependent noise estimate comprises setting a fixed threshold amplitude for piston position detection; collecting radar measurements at multiple positions between the radar sensor and the piston; and estimating noise statistics at the multiple positions between the radar sensor and the piston using the radar measurements.

Implementation F6 is the system of any one of implementations F1-F5, wherein setting the position-dependent threshold amplitude for piston position detection comprises automatically setting the position-dependent threshold amplitude for piston position detection based on the calculated position-dependent noise estimate.

Implementation F7 is the system of any one of implementations F1-F6, wherein automatically setting the position-dependent threshold amplitude for piston position detection based on the calculated position-dependent noise estimate comprises automatically setting the position-dependent threshold amplitude for piston position detection at a defined number of standard deviations above a mean value of the calculated position-dependent noise estimate.

Implementation F8 is the system of any one of implementations F1-F7, wherein calibrating the radar measurements acquired by the radar sensor to correct for the multi-path position error comprises collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions.

Implementation F9 is the system of any one of implementations F1-F8, wherein determining the function that estimates the multi-path position error at various piston positions comprises fitting a B-spline curve to error measurements that represent differences between (i) the uncalibrated piston position measurements collected using the radar sensor and (ii) the reference positions of the piston that correspond to the uncalibrated piston position measurements.

Implementation F10 is the system of any one of implementations F1-F9, wherein calibrating the radar measurements acquired by the radar sensor to adjust for temperature fluctuations within the hydraulic cylinder comprises determining a function for estimating a temperature correction that minimizes an error between (i) the calibrated radar measurements and (ii) the reference positions of the piston that correspond to the calibrated radar measurements; and adjusting the calibrated radar measurements by the temperature correction estimated by the determined function.

Implementation F11 is the system of any one of implementations F1-F10, wherein determining the function for estimating the temperature correction that minimizes the error between (i) the calibrated radar measurements and (ii) the reference positions of the piston that correspond to the calibrated radar measurements comprises determining one or more coefficients corresponding to an approximation of the error between (i) the calibrated radar measurements and (ii) the reference positions of the piston that correspond to the calibrated radar measurements.

Implementation G1 is a system comprising a hydraulic cylinder that comprises a piston and a radar sensor; a temperature calibration module configured to collect, using the radar sensor, error measurements at multiple temperatures within the hydraulic cylinder, wherein the error measurements represent a difference between (i) radar measurements acquired by the radar sensor and (ii) reference positions of a piston that correspond to the radar measurements; the temperature calibration module is configured to calibrate the radar measurements acquired by the radar sensor to adjust for temperature fluctuations within the hydraulic cylinder.

Implementation G2 is the system of implementation G1, the system further comprises a noise estimation module configured to calculate a position-dependent noise estimate; and a threshold amplitude setting module configured to set a position-dependent threshold amplitude for piston position detection based on the calculated position-dependent noise estimate. The piston is determined to be detected at a particular position if a reflected signal received at the radar sensor exceeds the position-dependent threshold amplitude at the particular position.

Implementation G3 is the system of any one of implementations G1-G2, wherein the system comprises a multi-path position error calibration module configured to calibrate radar measurements acquired by the radar sensor to correct for a multi-path position error.

Implementation G4 is the system of any one of implementations G1-G3, wherein the system comprises a reference position sensor, wherein the reference positions of the piston that correspond to the radar measurements are provided by the reference position sensor.

Implementation G5 is the system of any one of implementations G1-G4, wherein the reference position sensor comprises a glass scale encoder coupled to the hydraulic cylinder.

Implementation G6 is the system of any one of implementations G1-G5, wherein calculating the position-dependent noise estimate comprises setting a fixed threshold amplitude for piston position detection; collecting radar measurements at multiple positions between the radar sensor and the piston; and estimating noise statistics at the multiple positions between the radar sensor and the piston using the radar measurements.

Implementation G7 is the system of any one of implementations G1-G6, wherein setting the position-dependent threshold amplitude for piston position detection comprises automatically setting the position-dependent threshold amplitude for piston position detection based on the calculated position-dependent noise estimate.

Implementation G8 is the system of any one of implementations G1-G7, wherein automatically setting the position-dependent threshold amplitude for piston position detection based on the calculated position-dependent noise estimate comprises automatically setting the position-dependent threshold amplitude for piston position detection at a defined number of standard deviations above a mean value of the calculated position-dependent noise estimate.

Implementation G9 is the system of any one of implementations G1-G8, wherein calibrating the radar measurements acquired by the radar sensor to correct for the multi-path position error comprises collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions.

Implementation G10 is the system of any one of implementations G1-G9, wherein determining the function that estimates the multi-path position error at various piston positions comprises fitting a B-spline curve to error measurements that represent differences between (i) the uncalibrated piston position measurements collected using the radar sensor and (ii) the reference positions of the piston that correspond to the uncalibrated piston position measurements.

Implementation G11 is the system of any one of implementations G1-G10, wherein calibrating the radar measurements acquired by the radar sensor to adjust for temperature fluctuations within the hydraulic cylinder comprises determining a function for estimating a temperature correction that minimizes an error between (i) the radar measurements acquired by the radar sensor and (ii) the reference positions of the piston that correspond to the radar measurements; and adjusting the radar measurements by the temperature correction estimated by the determined function.

Implementation G12 is the system of any one of implementations G1-G11, wherein determining the function for estimating the temperature correction that minimizes the error between (i) the radar measurements acquired by the radar sensor and (ii) the reference positions of the piston that correspond to the radar measurements comprises determining one or more coefficients corresponding to an approximation of the error between (i) the radar measurements acquired by the radar sensor and (ii) the reference positions of the piston that correspond to the radar measurements.

Implementation H1 is one or more machine-readable storage devices have encoded thereon computer readable instructions for causing one or more processing devices to perform operations for calibrating a radar sensor used in a hydraulic cylinder, the operations comprise: calculating a position-dependent noise estimate; setting a position-dependent threshold amplitude for piston position detection based on the calculated position-dependent noise estimate, wherein a piston is determined to be detected at a particular position if a reflected signal received at the radar sensor exceeds the position-dependent threshold amplitude at the particular position; and calibrating radar measurements acquired by the radar sensor to correct for a multi-path position error.

Implementation H2 is the one or more machine-readable storage devices of implementation H1, the operations further comprise collecting, using the radar sensor, error measurements at multiple temperatures within the hydraulic cylinder, wherein the error measurements represent a difference between (i) the calibrated radar measurements and (ii) reference positions of the piston that correspond to the calibrated radar measurements; and calibrating the radar measurements acquired by the radar sensor to adjust for temperature fluctuations within the hydraulic cylinder.

Implementation H3 is the one or more machine-readable storage devices of any one of implementations H1-H2, wherein the reference positions of the piston that correspond to the calibrated radar measurements can be provided by a reference position sensor.

Implementation H4 is the one or more machine-readable storage devices of any one of implementations H1-H3, wherein the reference position sensor comprises a glass scale encoder coupled to the hydraulic cylinder.

Implementation H5 is the one or more machine-readable storage devices of any one of implementations H1-H4, wherein calculating the position-dependent noise estimate comprises setting a fixed threshold amplitude for piston position detection; collecting radar measurements at multiple positions between the radar sensor and the piston; and estimating noise statistics at the multiple positions between the radar sensor and the piston using the radar measurements.

Implementation H6 is the one or more machine-readable storage devices of any one of implementations H1-H5, wherein setting the position-dependent threshold amplitude for piston position detection comprises automatically setting the position-dependent threshold amplitude for piston position detection based on the calculated position-dependent noise estimate.

Implementation H7 is the one or more machine-readable storage devices of any one of implementations H1-H6, wherein automatically setting the position-dependent threshold amplitude for piston position detection based on the calculated position-dependent noise estimate comprises automatically setting the position-dependent threshold amplitude for piston position detection at a defined number of standard deviations above a mean value of the calculated position-dependent noise estimate.

Implementation H8 is the one or more machine-readable storage devices of any one of implementations H1-H7, wherein calibrating the radar measurements acquired by the radar sensor to correct for the multi-path position error comprises collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions.

Implementation H9 is the one or more machine-readable storage devices of any one of implementations H1-H8, wherein determining the function that estimates the multi-path position error at various piston positions comprises fitting a B-spline curve to error measurements that represent differences between (i) the uncalibrated piston position measurements collected using the radar sensor and (ii) the reference positions of the piston that correspond to the uncalibrated piston position measurements.

Implementation H10 is the one or more machine-readable storage devices of any one of implementations H1-H9, wherein calibrating the radar measurements acquired by the radar sensor to adjust for temperature fluctuations within the hydraulic cylinder comprises determining a function for estimating a temperature correction that minimizes an error between (i) the calibrated radar measurements and (ii) the reference positions of the piston that correspond to the calibrated radar measurements; and adjusting the calibrated radar measurements by the temperature correction estimated by the determined function.

Implementation H11 is the one or more machine-readable storage devices of any one of implementations H1-H10, wherein determining the function for estimating the temperature correction that minimizes the error between (i) the calibrated radar measurements and (ii) the reference positions of the piston that correspond to the calibrated radar measurements comprises determining one or more coefficients corresponding to an approximation of the error between (i) the calibrated radar measurements and (ii) the reference positions of the piston that correspond to the calibrated radar measurements.

Implementation H12 is the one or more machine-readable storage devices of any one of implementations H1-H11, wherein the operations further comprise defining a plurality of sections of the hydraulic cylinder; identifying that the piston is likely to be present in a particular section of the plurality of sections of the hydraulic cylinder; and varying one or more measurement parameters to pre-defined values corresponding to the particular section.

Implementation H13 is the one or more machine-readable storage devices of any one of implementations H1-H12, wherein the one or more measurement parameters comprises at least one of a receiver gain associated with the radar sensor or a number of measurements averaged by the radar sensor.

Implementation H14 is the one or more machine-readable storage devices of any one of implementations H1-H13, the operations further comprise defining a plurality of sections of the hydraulic cylinder; identifying that the piston is likely to be present in a particular section of the plurality of sections of the hydraulic cylinder; and operating the radar sensor to acquire data only for the particular section.

Implementation I1 is one or more machine-readable storage devices have encoded thereon computer readable instructions for causing one or more processing devices to perform operations for calibrating a radar sensor used in a hydraulic cylinder, the operations comprising: collecting, using the radar sensor, error measurements at multiple temperatures within the hydraulic cylinder, wherein the error measurements represent a difference between (i) radar measurements acquired by the radar sensor and (ii) reference positions of a piston that correspond to the radar measurements; and calibrating the radar measurements acquired by the radar sensor to adjust for temperature fluctuations within the hydraulic cylinder.

Implementation I2 is the one or more machine-readable storage devices of implementation I1, the operations comprise calculating a position-dependent noise estimate; and setting a position-dependent threshold amplitude for piston position detection based on the calculated position-dependent noise estimate, wherein the piston is determined to be detected at a particular position if a reflected signal received at the radar sensor exceeds the position-dependent threshold amplitude at the particular position.

Implementation I3 is the one or more machine-readable storage devices of any one of implementations I1-I2, the operations comprise calibrating radar measurements acquired by the radar sensor to correct for a multi-path position error.

Implementation I4 is the one or more machine-readable storage devices of any one of implementations I1-I3, wherein the reference positions of the piston that correspond to the radar measurements can be provided by a reference position sensor.

Implementation I5 is the one or more machine-readable storage devices of any one of implementations I1-I4, wherein the reference position sensor comprises a glass scale encoder coupled to the hydraulic cylinder.

Implementation I6 is the one or more machine-readable storage devices of any one of implementations I1-I5, wherein calculating the position-dependent noise estimate comprises setting a fixed threshold amplitude for piston position detection; collecting radar measurements at multiple positions between the radar sensor and the piston; and estimating noise statistics at the multiple positions between the radar sensor and the piston using the radar measurements.

Implementation I7 is the one or more machine-readable storage devices of any one of implementations I1-I6, wherein setting the position-dependent threshold amplitude for piston position detection comprises automatically setting the position-dependent threshold amplitude for piston position detection based on the calculated position-dependent noise estimate.

Implementation I8 is the one or more machine-readable storage devices of any one of implementations I1-I7, wherein automatically setting the position-dependent threshold amplitude for piston position detection based on the calculated position-dependent noise estimate comprises automatically setting the position-dependent threshold amplitude for piston position detection at a defined number of standard deviations above a mean value of the calculated position-dependent noise estimate.

Implementation I9 is the one or more machine-readable storage devices of any one of implementations I1-I8, wherein calibrating the radar measurements acquired by the radar sensor to correct for the multi-path position error comprises collecting (i) uncalibrated piston position measurements using the radar sensor and (ii) reference positions of the piston that correspond to the uncalibrated piston position measurements; comparing the uncalibrated piston position measurements and the reference positions of the piston that correspond to the uncalibrated piston position measurements to determine a function that estimates the multi-path position error at various piston positions; and adjusting the radar measurements by the multi-path position error estimated by the function at the corresponding piston positions.

Implementation I10 is the one or more machine-readable storage devices of any one of implementations I1-I19, wherein determining the function that estimates the multi-path position error at various piston positions comprises fitting a B-spline curve to error measurements that represent differences between (i) the uncalibrated piston position measurements collected using the radar sensor and (ii) the reference positions of the piston that correspond to the uncalibrated piston position measurements.

Implementation I11 is the one or more machine-readable storage devices of any one of implementations I1-I10, wherein calibrating the radar measurements acquired by the radar sensor to adjust for temperature fluctuations within the hydraulic cylinder comprises determining a function for estimating a temperature correction that minimizes an error between (i) the radar measurements acquired by the radar sensor and (ii) the reference positions of the piston that correspond to the radar measurements; and adjusting the radar measurements by the temperature correction estimated by the determined function.

Implementation I12 is the one or more machine-readable storage devices of any one of implementations I1-I11, wherein determining the function for estimating the temperature correction that minimizes the error between (i) the radar measurements acquired by the radar sensor and (ii) the reference positions of the piston that correspond to the radar measurements comprises determining one or more coefficients corresponding to an approximation of the error between (i) the radar measurements acquired by the radar sensor and (ii) the reference positions of the piston that correspond to the radar measurements.

Implementation I13 is the one or more machine-readable storage devices of any one of implementations I1-I12, wherein the operations further comprise defining a plurality of sections of the hydraulic cylinder; identifying that the piston is likely to be present in a particular section of the plurality of sections of the hydraulic cylinder; and varying one or more measurement parameters to pre-defined values corresponding to the particular section.

Implementation I14 is the one or more machine-readable storage devices of any one of implementations I1-I13, wherein the one or more measurement parameters comprises at least one of a receiver gain associated with the radar sensor or a number of measurements averaged by the radar sensor.

Implementation I15 is the one or more machine-readable storage devices of any one of implementations I1-I14, wherein the operations further comprise defining a plurality of sections of the hydraulic cylinder; identifying that the piston is likely to be present in a particular section of the plurality of sections of the hydraulic cylinder; and operating the radar sensor to acquire data only for the particular section.

1. A method for calibrating a radar sensor used in a hydraulic cylinder, the method comprising:
calculating a position-dependent noise estimate;
setting a position-dependent threshold amplitude for piston position detection based on the calculated position-dependent noise estimate, wherein a piston is determined to be detected at a particular position if a reflected signal received at the radar sensor exceeds the position-dependent threshold amplitude at the particular position; and
calibrating radar measurements acquired by the radar sensor to correct for a multi-path position error.

2. The method of claim 1 further comprising:
collecting, using the radar sensor, error measurements at multiple temperatures within the hydraulic cylinder, wherein the error measurements represent a difference between (i) the calibrated radar measurements and (ii) reference positions of the piston that correspond to the calibrated radar measurements; and
calibrating the radar measurements acquired by the radar sensor to adjust for temperature fluctuations within the hydraulic cylinder.

3. The method of claim 2, wherein the reference positions of the piston that correspond to the calibrated radar measurements are provided by a reference position sensor.

4. The method of claim 1, wherein calculating the position-dependent noise estimate comprises:
setting a threshold amplitude for piston position detection;
collecting radar measurements at multiple positions between the radar sensor and the piston; and
estimating noise statistics at the multiple positions between the radar sensor and the piston using the radar measurements.

5. The method of claim 1, wherein setting the position-dependent threshold amplitude for piston position detection comprises automatically setting the position-dependent threshold amplitude for piston position detection based on the calculated position-dependent noise estimate.

6. The method of claim 5, wherein automatically setting the position-dependent threshold amplitude for piston position detection based on the calculated position-dependent noise estimate comprises automatically setting the position-dependent threshold amplitude for piston position detection at a defined number of standard deviations above a mean value of the calculated position-dependent noise estimate.

7. The method of claim 1, wherein calibrating the radar measurements acquired by the radar sensor to correct for the multi-path position error comprises:
collecting (i) uncalibrated piston position measurements using the radar sensor and (ii) reference positions of the piston that correspond to the uncalibrated piston position measurements;
comparing the uncalibrated piston position measurements and the reference positions of the piston that correspond to the uncalibrated piston position measurements to determine a function that estimates the multi-path position error at various piston positions; and
adjusting the radar measurements by the multi-path position error estimated by the function at the corresponding piston positions.

8. The method of claim 7, wherein determining the function that estimates the multi-path position error at various piston positions comprises fitting a B-spline curve to error measurements that represent differences between (i) the uncalibrated piston position measurements collected using the radar sensor and (ii) the reference positions of the piston that correspond to the uncalibrated piston position measurements.

9. The method of claim 2, wherein calibrating the radar measurements acquired by the radar sensor to adjust for temperature fluctuations within the hydraulic cylinder comprises:
determining a function for estimating a temperature correction that reduces an error between (i) the calibrated radar measurements and (ii) the reference positions of the piston that correspond to the calibrated radar measurements; and
adjusting the calibrated radar measurements by the temperature correction estimated by the determined function.

10. The method of claim 9, wherein determining the function for estimating the temperature correction that minimizes the error between (i) the calibrated radar measurements and (ii) the reference positions of the piston that correspond to the calibrated radar measurements comprises:
determining one or more coefficients corresponding to an approximation of the error between (i) the calibrated radar measurements and (ii) the reference positions of the piston that correspond to the calibrated radar measurements.

11. The method of claim 1, further comprising:
determining that the piston is likely to be present in a particular section of a plurality of sections that span a length of a cylinder body of the hydraulic cylinder, wherein each section corresponds to a respective portion of the length of the cylinder body; and
adjusting one or more measurement parameters to values corresponding to the particular section from the plurality of sections.

12. The method of claim 11, wherein the one or more measurement parameters comprises at least one of a receiver gain associated with the radar sensor or a number of measurements averaged by the radar sensor.

13. The method of claim 1, further comprising:
determining that the piston is likely to be present in a particular section of a plurality of sections that span a length of a cylinder body of the hydraulic cylinder, wherein each section corresponds to a respective portion of the length of the cylinder body; and
operating the radar sensor to acquire measurement data associated with the particular section.

14. The method of claim 1, further comprising:
determining (i) an initial estimated position of the piston in the hydraulic cylinder and (ii) a temperature measurement representative of a temperature associated with the hydraulic cylinder.

15. The method of claim 14, wherein the temperature measurement is a measurement of a temperature of a fluid within the hydraulic cylinder.

16. The method of claim 1, further comprising:
determining a plurality of calibration temperatures based on a temperature parameter associated with the hydraulic cylinder;
determining a plurality of calibration positions based on an initial estimated position of the piston in the hydraulic cylinder, wherein a plurality of defined sections comprise the plurality of calibration positions, wherein the plurality of defined sections span a length of a cylinder body of the hydraulic cylinder, and wherein each section from the plurality of defined sections corresponds to a respective portion of the length of the cylinder body; and
generating a plurality of functions based on the plurality of calibration positions and the plurality of calibration temperatures, wherein each function from the plurality of functions estimates the multi-path position error at various piston positions of the hydraulic cylinder, wherein each function from the plurality of functions is generated from a respective combination of at least one temperature from the plurality of calibration temperatures and at least one calibration position from the plurality of calibration positions.

17. The method of claim 16, wherein determining the function that estimates the multi-path position error at various piston positions comprises:
selecting one or more functions from the plurality of functions based on a first estimated position of the piston in the hydraulic cylinder and a first temperature parameter of the hydraulic cylinder.

18. The method of claim 17, further comprising:
predicting, using the one or more selected functions, the multi-path position error, wherein the predicting comprises reducing, using the one or more selected functions, an error between (i) the calibrated radar measurements and (ii) reference positions of the piston that correspond to the calibrated radar measurements; and
adjusting the calibrated radar measurements by the multi-path position error predicted by the one or more selected functions.

19. A system comprising:
at least one processor; and
one or more storage devices communicatively coupled to the at least one processor, the one or more storage devices storing instructions which, when executed by the at least one processor, cause the at least one processor to perform operations comprising:
calculating a position-dependent noise estimate;
setting a position-dependent threshold amplitude for piston position detection based on the calculated position-dependent noise estimate, wherein a piston is determined to be detected at a particular position if a reflected signal received at a radar sensor exceeds the position-dependent threshold amplitude at the particular position; and
calibrating radar measurements acquired by the radar sensor to correct for a multi-path position error.

20. One or more non-transitory machine-readable storage devices having encoded thereon computer readable instructions for causing one or more processing devices to perform operations for calibrating a radar sensor used in a hydraulic cylinder, wherein the operations comprise:
calculating a position-dependent noise estimate;
setting a position-dependent threshold amplitude for piston position detection based on the calculated position-dependent noise estimate, wherein a piston is determined to be detected at a particular position if a reflected signal received at the radar sensor exceeds the position-dependent threshold amplitude at the particular position; and
calibrating radar measurements acquired by the radar sensor to correct for a multi-path position error.
